(19) United States
(12) Patent Application Publication
(10) Pub. No.: US 2009/0254321 A1
(43) Pub. Date: Oct. 8, 2009

(54) Process for making models of the building blocks of our universe

(76) Inventor: John R. Ross, Del Mar, CA (US)

Correspondence Address: ROSS PATENT LAW OFFICE, P.O. BOX 2138, DEL MAR, CA, 92014, US

(21) Appl. No.: 12/455,989

(22) Filed: Jun. 9, 2009

Related U.S. Application Data
(63) Continuation-in-part of application No. 11/108,938, filed on Apr. 18, 2005, now abandoned.
Application No. 11/108,938 is a continuation-in-part of application No. 10/655,817, filed on Sep. 5, 2003, now abandoned.
Application No. 10/655,817 is a continuation-in-part of application No. 10/436,286, filed on May 12, 2003, now abandoned.
Application No. 10/436,286 is a continuation-in-part of application No. 10/251,577, filed on Sep. 21, 2002, now abandoned.
Application No. 10/251,577 is a continuation-in-part of application No. 09/908,297, filed on Jul. 17, 2001, now abandoned.
Application No. 10/655,817 is a continuation-in-part of application No. 10/161,823, filed on Jun. 3, 2002, now abandoned.

(51) Int. Cl. G06G 7/48

(52) U.S. Cl. 703/6

(57) ABSTRACT

A process for making models of very small things and very big things. Since the structure of the smallest and largest things in our Universe are unknown to science and hold the key to understanding how our Universe was created and functions, the Ross Model is a process for modeling the secrets of our Universe. In preferred embodiments the present invention is used to create models of subatomic particles (including tronnies, entrons, photons, electrons, protons) and other things in our Universe such as atoms, molecules, electricity, magnetism, gravity, Black Holes, galaxies, the Big Bang, and our Universe itself, including its shell.

### CROSS REFERENCE TO RELATED APPLICATIONS

This application is a Continuation-in-Part application of Ser. No. 11/108,938 filed Apr. 18, 2005 which was a Continuation in Part of Ser. No. 10/655,817 filed Sep. 5, 2003, Ser. No. 10/436,286 filed May 12, 2003, Ser. No. 10/251,577 filed Sep. 21, 2002 and Ser. No. 09/908,297, filed Jul. 17, 2001, which was a Continuation-in-Part of Ser. No. 10/161,823 filed Jun. 3, 2002, now abandoned, all of which are incorporated herein by reference.

### FIELD OF THE INVENTION

The present invention relates to processes for making models and in particular processes for making models of very small things.

### BACKGROUND OF THE INVENTION

### Search for the Truth

Since the beginning of human civilization mankind has searched for explanations of the origin of our Universe, how it was put together and how it works. Early explanations involved supernatural beings and religions evolved from these efforts. More recent explanations have involved complicated mathematical explanations based on experimental evidence, some involving multiple extra dimensions. Many millions of dollars are being spent in the United States alone and similar efforts are underway in other countries in search of the ultimate building blocks of our Universe and a theory or explanation that fully explains all of nature. This sought after theory is referred to as the “theory of everything”.

### Popular Models

Popular scientific models propose a complicated set of elementary particles that are supposed to be building blocks of matter. These include electrons (positive and negative) and six types of quarks (three of which make a proton and three of which make a neutron) and neutrinos. Neutrinos are supposed to be produced in the sun, have the same spin as the electron, travel at, or very close to, the speed of light and most of them that illuminate the earth, according to accepted theories, pass right through it. Popular models also include a complicated set of forces. These include electromagnetic forces (that combines Coulomb forces with magnetic forces), the “strong” force holding atomic nuclei together, a “weak” force related to beta particle decay and the force of gravity. Prior art models include a spectrum of electromagnetic radiation, including cosmic rays, gamma rays, x-rays ultraviolet light, visible light, infrared light, millimeter waves, microwaves and radio waves. These models include the photon which is supposed to be a quantum of electromagnetic energy having some features of a particle. Relativity theories attempt to model the effects of traveling at speeds close to the speed of light and to describe gravitational effects.

### Important Known Facts

The earth and our sun are part of the Milky Way Galaxy. The Milky Way is an average size galaxy that has in it about 100 billion stars. (We refer to one of those stars as our “sun”.) There are in our Universe more than 80 billion galaxies. This means there are more than (80×10⁹ galaxies)×(100×10⁹ stars/galaxy)=8×10²¹ suns in our Universe. That is 10 trillion billion stars. Many if not almost all of these stars are believed to have planets orbiting them and many if not most of these planets are likely to have moons. The distance to the edge of the observable universe is about 10²⁶ meters. That is 100 trillion trillion meters. Our Universe is a very big place with lots of stuff in it.

Our Universe is currently expanding with the distances between galaxies (or clusters of galaxies) expanding faster depending on how far away the galaxies (or clusters) are from each other. We estimate the age of our Universe by dividing the distance to each galaxy by the speed at which the galaxy is moving away from our galaxy, the Milky Way. We get roughly the same answer for each galaxy for which we have a good estimate of distance. Based on these measurements and calculations scientists believe that our Universe originated about to 13 to 15 billion years ago in a Big Bang explosion. About 300,000 years after the Big Bang a very large number of small atoms formed, mostly hydrogen atoms and a much smaller number of helium atoms. Over time these atoms collected into gas clouds that later became stars. In the extreme heat in the core of stars hydrogen atoms combined to produce helium and hydrogen and helium combined to produce larger atoms and these larger atoms combine with other atoms to make even larger atoms. Stars collected into galaxies. Some exploded spreading the heavier atoms they produced out into interstellar space.

Planets, including our earth, formed from collections of the atomic debris of exploded stars. Some planets are mostly hot gases but scientists believe there are many planets with conditions similar to conditions on earth that are capable of supporting the development of life.

### Atoms

There are 92 types of naturally occurring atoms, each with a nucleus and a unique number of orbiting electrons. Atoms each have a single relatively heavy positively charged nucleus and the nucleus is surrounded by one or more electrons, each of which has a negative charge of −e. The number of orbiting electrons in a charge neutral atom represents the atomic number of the atom. Some of the more familiar atoms are listed below:

TABLE I
Typical Atoms

| Number of Electrons | | |
|---|---|---|
| In Orbit | Atom | Symbol |
| 1 | Hydrogen | H |
| 2 | Helium | He |
| 6 | Carbon | C |
| 7 | Nitrogen | N |
| 8 | Oxygen | O |
| 10 | Neon | Ne |
| 11 | Sodium | Na |
| 12 | Magnesium | Mg |
| 13 | Aluminum | Al |
| 14 | Silicon | Si |
| 16 | Sulfur | S |
| 18 | Argon | Ar |
| 20 | Calcium | Ca |
| 26 | Iron | Fe |
| 29 | Copper | Cu |
| 47 | Silver | Ag |
| 79 | Gold | Au |
| 82 | Lead | Pb |
| 92 | Uranium | U |

The net charge of the nucleus of each neutral atom is equal and opposite the total charge of the number of electrons in orbit around the nucleus. So for example the net charge on the helium nucleus is +2e and the net charge of its two orbiting electrons is −2e. The net charge of the helium atom is 0 (since +2e added to −2e=0).

### Electrons

There are two types of electrons: (1) the type most people are familiar with that has a negative charge of −e (its official name is “negatron” but it is usually referred to as an “electron”) and (2) the type most people are not familiar with that has a positive charge of +e and is called a “positron”. The positron is the anti-particle of the negative electron. This anti-particle is exactly like the negative electron except for its positive charge of +e. Pairs of electrons (one negatron and one positron) can be produced when high-energy photons (called gamma rays or gamma ray photons) interact with matter. When an electron and a positron combine they both vanish and are replaced by high-energy photons. These processes are respectively called “pair production” and “electron-positron annihilation”.

### Photons

Visible light is a part of an electromagnetic spectrum which also includes x-rays, microwaves, radio waves, infrared light and ultraviolet light. For more than 100 years scientists have known that the energy of the electromagnetic spectrum is “quantized”; which means light (and other forms of electromagnetic energy) comes in separate and distinct “quantities” of energy. These separate and distinct quantities of energy are called photons. Scientists do not know what a photon is or what it looks like but they do know that the energy of a photon is:

Eₚₕₒₜₒₙ=hc/λ (1)

Where h is Planck's constant=6.626×10⁻³⁴ Nms=6.626×10⁻³⁴ Js. N is the symbol for newtons, m is meters and s is seconds. A newton-meter, Nm is a joule, J. The symbol c is the speed of light, c=3×10⁸ m/s, and λ is the wavelength of the photon, so:

$$\begin{matrix}{E}_{photon} = hc \text{/} λ \\ = ( 6.626 \times {10}^{34} Nms ) \times ( 3 \times {10}^{8} m \text{/} s ) \\ = 1.99 \times {10}^{- 25} {Nm}^{2} \text{/} λ or 1.99 \times {10}^{- 25} J m \text{/} λ\end{matrix}$$

The units of wavelength, λ, are meters so the photon energy, Eₚₕₒₜₒₙ, is in units of newton-meters which is the same as joules (i.e. one J=one Nm). Planck's constant can also be written with electron-volt, eV, units: h=4.136×10⁻¹⁵ eVs. Readers should note that the smaller the wavelength of the photon the larger is its energy. Radio wave photons have relatively long wavelengths and gamma ray photons have relatively short wavelengths. Visible light photons are somewhere in the middle.

### Mass, Energy Conversion Units and Universal Constants

Existing reference books and the Internet contain precisely measured values of the masses of atoms and sub-atomic particles and their equivalent energy (based on E=mc²), and provide precise values of important conversion units and universal constants such as the electron charge and the vacuum speed of light. Some of these values needed to understand the Ross Model are listed in Tables II, III and IV. To follow some of the math in the following section, readers may want to refer from time to time to the values in this table.

TABLE II
Masses of Some Small Atoms and Particles

| | | Mass | Energy |
|---|---|---|---|
| Particle or Atom | Symbol | (kg) | (MeV) |
| Electron at rest | e− | 9.109 3897 × 10⁻³¹ | 0.510 712 57 |
| Positron at rest | e+ | 9.109 3897 × 10⁻³¹ | 0.510 712 57 |
| Proton | p | 1.672 6231 × 10⁻²⁷ | 938.272 338 |
| Neutron | n | 1.674 9286 × 10⁻²⁷ | 939.565 628 |
| Deuteron | d | 3.343 5860 × 10⁻²⁷ | 1875.613 39 |
| Tritium isotope | ³H | 5.008 2711 × 10⁻²⁷ | 2807.857 70 |
| Hydrogen one atom | ¹H | 1.673 5340 × 10⁻²⁷ | 938.256 992 |
| Helium 4 atom | ⁴He | 6.646 4835 × 10⁻²⁷ | 3726.311922 |

TABLE III
Some Important Conversion Units

| | | |
|---|---|---|
| One electron volt | eV = 1.602 177 33 × 10⁻¹⁹ J | joules |
| | eV = 1.783 662 70 × 10⁻³⁶ kg | kilograms |
| | eV = 96.49 kJ/mole | kilo-joules per mol |
| One atomic mass unit | amu = 1.660 5402 × 10⁻²⁷ kg | kilograms |
| | amu = 932.0 MeV | million electron-volts |
| One kilogram | kg = 8.987551787 × 10¹⁶ J | joules |
| Joule (energy) | J = kgm²/s² | kilogram meter squared per second squared |
| Newton (force) | N = kgm/s² | kilogram meter per second squared |
| λ | | |

TABLE IV
Universal Constants

| | | |
|---|---|---|
| Speed of light in vacuum | c = 2.99 792 458 × 10⁸ m/s | meters per second |
| Planks constant | h = 6.626 0755 × 10⁻³⁴ Js | joule-second |
| | h = 4.135 6692 × 10⁻¹⁵ eVs | electron-volt seconds |
| Avogadro constant | N_{A} = 6.022 1367 × 10²³/mole | per mole |
| Coulomb constant | k = 8.99 × 10⁹ Nm²/C² | newton meter²/coulomb² |
| Pi | Π = 3.1416 | |
| Electron Charge | | |
| Elementary charge | e = 1.602 177 33 × 10⁻¹⁹ C | coulombs |
| Ampere | Amp = 1 C/s | coulomb per second |
| | Amp = 6.24 × 10¹⁸ e/s | electrons/second |
| Wein's Law | λ = 2.898 × 10⁻³ mK/T | |

where λ is the peak wavelength of radiation emitted from a body at temperature T in degrees Kelvin.

The electrical force (also called the “Coulomb Force”) F, between stationary charged particles is:

F=kQ₁Q₂/r², (2)

where k=8.99×10⁹ N-m²/C², Q₁ and Q₂ are the charges in Coulombs of the particles and r is the distance between the particles.

Avogadro's constant from Table IV represents the number of atoms of a particular material in a number of grams equal to the atomic mass number of the material. Pi (π) from Table IV is the ratio of the circumference of a circle to the circle's diameter. Plank's constant from Table IV gives us the energy of a photon using equation (1) if we know its wavelength.

### Need for a Simpler Process

Stephen Hawkins in his book, The Theory of Everything, complained that science had become too complicated for philosophers and that they had ceased asking questions such as: “Did the universe have a beginning?” and he concluded his text as follows: “However, if we discover a complete theory, it should in time be understandable in broad principal by everyone, not just a few scientists. Then we shall all be able to take part in the discussion of why the universe exists. If we find the answer to that, it would be the ultimate triumph of human reason. For then we would know the mind of God.”

What is needed is a simple process for making models of photons, electrons, protons, neutrons, atoms, molecules, electricity, magnetism, heat, gravity and everything else in our Universe.

### SUMMARY OF THE INVENTION

I call the present invention the “Ross Model”. It is a process for making models of very small things and very big things. Since the structure of the smallest and largest things in our Universe are unknown to science and hold the key to understanding how our Universe was created and functions, the Ross Model is a process for modeling the secrets of our Universe. In preferred embodiments the present invention is used to create models of subatomic particles (including tronnies, entrons, photons, electrons, protons) and other things in our Universe such as atoms, molecules, electricity, magnetism, gravity, Black Holes, galaxies, the Big Bang, and our Universe itself, including its shell. The present invention also provides a process for modeling tronnies and entrons, each of which are currently unknown to science. In step-by-step processes, the internal structures of photons, electrons, protons and atomic nuclei can be modeled and graphical, physical or computer models of the particles can be produced. The Ross Model may also be applied to model electricity, magnetism, gravity and the evolution of universes including the creation and future destruction of our Universe to create our successor universe. The models produced using the Ross Model may be physical models, graphical models or computer models. Some of the building blocks of our Universe are described briefly below:

### The Tronnie

The present invention is based on the existence of a previously unknown point particle (which I discovered and call the “tronnie”) from which everything in our Universe is made. Tronnies have no mass and no volume but they do have a charge of plus e or minus e. So they carry the Coulomb force which expands out from each tronnie at the speed of light (3×10⁸ m/s) repelling like tronnies and attracting unlike tronnies. Each tronnie being exactly like itself repels itself with its own Coulomb force, so each tronnie is always traveling at the speed of light or greater, never less than the speed of light!

### The Entron

My model also reveals a previously unknown mass-energy quantum which I call the “entron” that is comprised of two tronnies, one plus and one minus. The two tronnies of the entron travel on opposite sides of a circle at a speed of 1.57 c (π/2 times the speed of light). The diameter of the circle may be any size from 1.44×10⁻¹⁸ m to a few centimeters. Entrons represent almost all of the mass/energy of our Universe. (The rest of the mass/energy of our Universe is represented by electrons and positrons.) All of the other massive objects in our Universe including protons derive their mass from electrons, positrons and entrons. Each photon is comprised of one entron.

### The Neutrino Entron

The most energetic entron and the most important entron in our Universe is the “neutrino entron” (with a mass of 1.67×10⁻²⁷ kg and energy of 1.503×10⁻¹¹ J or 931 MeV) which represents almost all of the mass of protons. These neutrino entrons also represent almost all of the mass of our Universe. Protons are destroyed in Black Holes at the center of each galaxy, and each destruction of a proton releases a neutrino entron as a “neutrino photon” from the black holes to provide the gravity of the galaxy.

### Photons

Photons are entrons traveling in a circle at a speed of 2 c (twice the speed of light) and forward at a speed of c (the speed of light). All of the energy of a photon is contained in its entron. The wavelength of the photon is 911.6 times the diameter of its entron and the diameter of the photon's circle is 0.6366 times the photon's wavelength.

### Naked Electrons

The Ross Model describes the internal structure of zero voltage electrons (which I call “naked electrons”). Naked electrons are comprised of one plus tronnie, traveling in a circle with a diameter of 1.46×10⁻¹⁸ m at a speed of 1.57 c and a frequency of 1.04×10²⁶ cycles per second, and two minus tronnies circling the path of the plus tronnie in circles of the same diameter and frequency at one-fourth period behind the plus tronnie. Naked electrons are self-propelled. Internal Coulomb forces within naked electrons propel the naked electrons at a speed of 2.18×10⁶ m/s giving it a kinetic energy of 2.16×10⁻¹⁸ J (13.5 eV).

### Energetic Electrons

Energetic electrons are combinations of naked electrons and at least one entron. Low energy entrons slow the electrons down. A captured 13.5 eV entron cancels the electron's natural kinetic energy and higher energy entrons propel the electron in the direction opposite its natural direction. Positrons, naked and energetic (as in prior art models) are the anti-particle of electrons and naked positrons are also self-propelled at the same speed of 2.18×10⁶ m/s.

### Naked Protons

Naked protons are comprised of a very energetic electron (having captured a neutrino entron (circling with a diameter of 0.840×10⁻¹⁵ m and two naked positrons circling the path of the very energetic electron at one-forth period behind the electron. Naked protons are self-propelled at an estimated speed of 4×10⁷ m/s which is a little faster than 10 percent of the speed of light.

### Energetic Protons

Naked protons are slowed down with the capture of several entrons with energies totaling 8.366 MeV to form the nucleus of a hydrogen atom. These entrons are released in processes in which four naked protons and two electrons joined together in a fusion process to form a helium nucleus which is the same as a naked alpha particle. These released entrons represent the heat/energy of the hydrogen bomb and the heat/energy of our sun and most of the stars.

### Alpha Particle

Naked alpha particles are each comprised of four naked protons and two naked electrons. Naked alpha particles (like naked electrons and naked protons) are self-propelled by internal Coulomb forces. The nucleus of the helium atom is an energetic alpha particle slowed down with a captured entrons some of which are in turn released when helium nuclei are fused to form the nuclei of larger atoms such as carbon, oxygen and neon.

### Atoms

The nucleus of the most abundant of isotope of carbon is a simple combination of three alpha particles; oxygen four alpha particles, neon five, magnesium six silicon seven and sulfur eight plus in each case entrons. The nuclei of the isotopes of all of the other atoms are combinations of thing that are available in abundance in stars (i.e. alpha particles, protons, electrons and positrons and entrons).

### Everything in Our Universe is Made from Two Halves of Nothing

Tronnies are point particles with no mass and no volume, so two of them (a plus tronnie and a minus tronnie) are two halves of nothing. Tronnies are the fundamental particles from which everything in our Universe is made. Entrons, naked electrons and naked positron are composite particles made from tronnies. Naked protons and naked alpha particles are also composite particles made from electrons positrons and entrons. Everything else in our Universe is made from these composite particles. So basically everything in our Universe is made from tronnies. By everything, I mean everything, including all atoms, molecules, heat, gravity, our earth, its moon our sun, our galaxy and all 100 billion galaxies in our Universe, all made from tronnies and composite particles that are made from tronnies. Tronnies, having no mass and no volume and opposite charges with the ability to create mass and energy and being two haves of nothing, provides a logical explanation for how a universe could be made from nothing (empty space).

### Internal Structures of Atoms and Sub-Atomic Particles

As explained above the present invention reveals the internal structure of photons, entrons, electrons, protons, and alpha particles and explains how these composite particles can be combined to form all atoms and molecules.

### Photons and Sub-Atomic Particles are Self-Propelled

Photons are each comprised of one entron traveling in a circle at a speed of 2 c and forward at a speed of c (the speed of light). Naked electrons, positrons, protons and alpha particles are self-propelled by their own internal Coulomb forces at a significant fraction of the speed of light but can capture low-energy entrons to slow down. High-energy electrons, positrons, protons and alpha particles are propelled by captured high-energy entrons, in directions opposite their natural direction of travel. These high-energy entrons each has a mass that corresponds to their energy based on Albert Einstein's famous equation:

E=mc² (3)

However the mass of the entrons add to the mass of the particles they are propelling. Therefore, the speed of the particles can only be increased with a corresponding increase in the mass of the particles. Thus, the Ross Model, like Albert Einstein's special theory of relativity, provides an explanation as to why the mass of particles traveling close to the speed of light have substantially greater mass as compared to similar slow speed particles. This increase in mass with energy results in a limit on the speed on the energetic particles when the mass of the propelling entron becomes very large compared to the mass of the particle being propelled.

### Gravity

Gravity, according to the present invention is produced in Black Holes with the destruction of protons and anti-protons which releases one neutrino photon with each proton and each anti-proton destroyed. The neutrino entron in each neutrino photon has a diameter of 1.46×10⁻¹⁸ (about a thousand times smaller than a proton and one hundred million times smaller than an atom) so the neutrino photon easily passes through objects like stars, planets and moons molecules, atoms and even protons. The neutron entron is about the same size as the electron and the positron. Coulomb force effects from the tronnies in each neutrino photon produce tiny forces on the charges in the objects through which the neutrino photons pass, pushing the objects back toward the source to the neutrino photons (i.e. Black Holes). Some of the neutrino entrons are temporally captured by electrons and positrons in objects such as the stars, planets and moons. These captured neutrino entrons are later released in random directions as neutrino photons; thereby giving these stars, planets and moons their gravity. Electrons in hydrogen atoms in interstellar space capture or scatter a portion of the neutrino photons to significantly reduce the neutrino photon flux from each galaxy that reaches distant galaxies.

### Anti-Gravity

Anti-gravity is produced by photon pressure from low-energy photons such as visible light photons which pass through interstellar space basically unimpeded, much more efficiently than gravity producing neutrinos. Therefore, photon pressure from stars of one galaxy is sufficient to provide a repulsive accelerating force on far distant galaxies. This force is small but it is constant and continuous (always accelerating every second) for billions of years. Thus, close-by galaxies are all accelerating toward each other due to the influence of penetrating neutrino entrons and far-away galaxies are expanding away from each other due to pressure from non-penetrating lower energy photons which are absorbed by or reflect from the components of the far-away galaxies. And the things responsible for the attraction and repulsion of galaxies are photons, nothing but photons, low energy photons pushing far away galaxies apart and neutrino photons pulling close-by galaxies together!

### Magnetism and Electricity

Magnetism is nothing but naked (zero voltage) electrons looping through and around magnetic materials at the naked electrons' natural speed of 2.18 million meters per second (2.18×10⁶ m/s) or faster. Our earth's magnet field is produced by these naked electrons that loop through and around our earth (with a diameter of about 6 million meters in a few seconds. The model also provides a new description of electricity and electric current.

### Our Universe is Contained in a Cold Plasma Shell

The Ross Model describes a cold plasma shell (of mostly naked electrons, positrons and protons) which surrounds and contains our Universe. This cold plasma shell has been reflecting low energy photons from the galaxies of our Universe like an integrating sphere since the formation of the galaxy. Therefore, low energy photons do not escape from our Universe. This very old reflected light produces the recently discovered uniform (in every direction) low-energy cosmic background radiation. The electrons in the cold plasma shell absorb the entrons of neutrino photons reaching the shell to produce very high-energy electrons each of which may capture two positrons to produce new protons which collect gamma rays to become hydrogen nuclei which in turn collect an electron to become hydrogen atoms providing material for the production of new galaxies at the currently growing boundary of our Universe.

### The Recycling of Universes

The Ross-Model provides a new insight into creation of our Universe and the ultimate destruction of our Universe in a Big Bang event that will be the birth of our successor Universe.

### A Work in Progress

Details of earlier versions of the Ross Model are provided in the patent applications referred to in the first sentence of this specification. These applications are incorporated herein by reference. This application is the latest version.

### BRIEF DESCRIPTION OF THE DRAWINGS

FIG. 1 is a graphical model of a tronnie and some of its Coulomb force waves.

FIGS. 2A and 2B are graphical models of an entron.

FIGS. 2C and 2D show an entron traveling at a speed of 2 c as part of a photon.

FIG. 3 is a graphical model of a photon in the photon's frame of reference.

FIG. 4 is a graphical model of a photon in a stationary frame of reference.

FIG. 5 is a graphical model of a naked electron.

FIG. 6A is a graphical model of a low-energy naked electron.

FIG. 6B is a graphical model of a high-energy naked electron.

FIG. 7 is a graphical model of a naked proton.

FIG. 8 is a graph showing electron and proton velocity as a function of entron energy.

FIG. 9 is a graphical model of a naked deuteron.

FIG. 10 is a graphical model of a naked triton.

FIG. 11 is a graphical model of a naked alpha particle.

FIG. 12 is a graphical model of our Universe with its cold plasma shell.

### DETAILED DESCRIPTION OF PREFERRED EMBODIMENTS

### Processes for Making Models

All embodiments of the present invention are processes for modeling things in our Universe. In preferred embodiments the present invention is used to create models of subatomic particles (including tronnies, entrons, photons, electrons, protons) and other things such as atoms, molecules, electricity, magnetism, gravity, Black Holes, galaxies, the Big Bang, and our Universe itself, including its shell. In step-by-step processes, the internal structures of photons, electrons, protons and atomic nuclei can be modeled and graphical, physical or computer models of the particles can be produced. The Ross Model may also be applied to model electricity, magnetism, gravity and the evolution of universes including the creation and destruction of our Universe. The models produced using the Ross Model may be physical models, graphical models mathematical models or computer models.

### The Tronnie and the Entron

All embodiments of the present invention depend on the existence of a previously unknown point particle which I call the “tronnie” and a new quantum of mass/energy which I call the “entron”. Both of these things were not known to science until I discovered them several years ago and described them in the more recent parent patent applications referred to at the beginning of this specification.

### Tronnies

Tronnies are the fundamental building blocks of our Universe. Tronnies have zero mass and zero volume and a charge of plus e or minus e, where e is the electron charge (approximately 1.602×10⁻¹⁹ coulombs). Plus tronnies repel other plus tronnies with the Coulomb force that travels at the speed of light and attract minus tronnies at the speed of light. Minus tronnies repel other minus tronnies with the same Coulomb force and attract plus tronnies at the speed of light. Tronnies having no mass offer no resistance to their own Coulomb force so each tronnie is repelled by its own Coulomb force at the speed of light or faster than the speed of light. Each plus tronnie basically is one half of nothing and each minus tronnie is the other half of nothing. Everything in our Universe is made from tronnies, each of which is one-half of nothing. There are an equal number of plus and minus tronnies in our Universe which explains how our Universe of more than 100 billion galaxies could evolve ultimately from nothing (empty space). FIG. 1 is a representation of a tronnie repelling itself along a curved path at a speed greater than the speed of light.

### The Amazing Entron

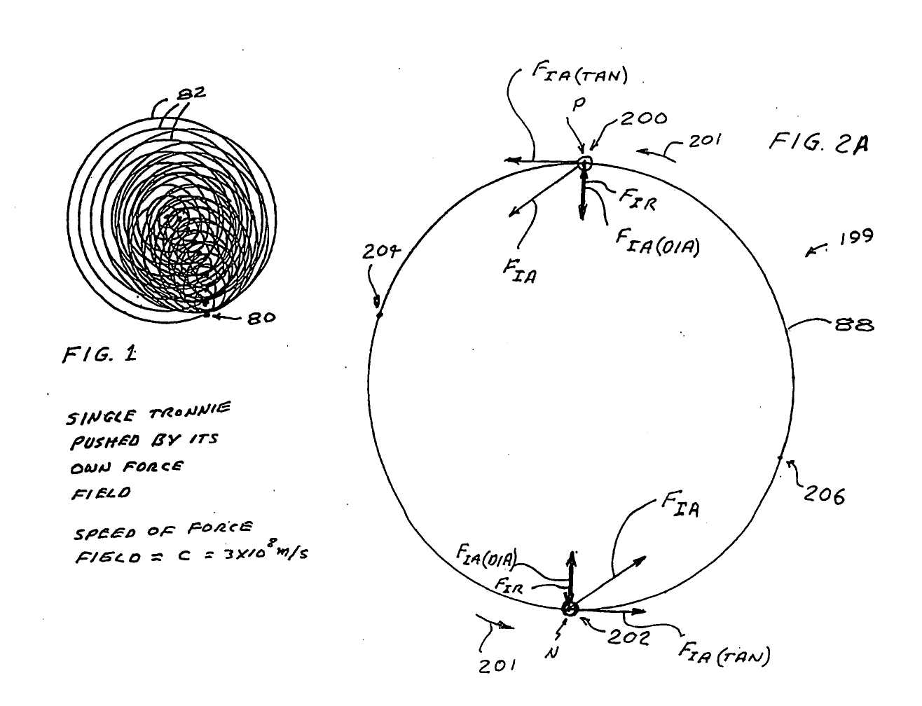

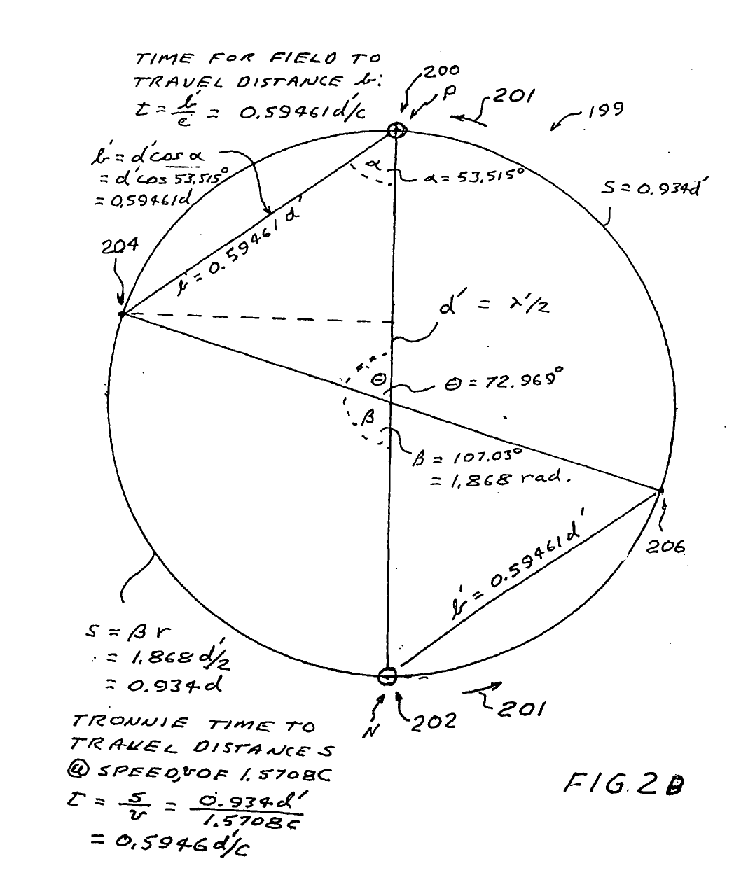

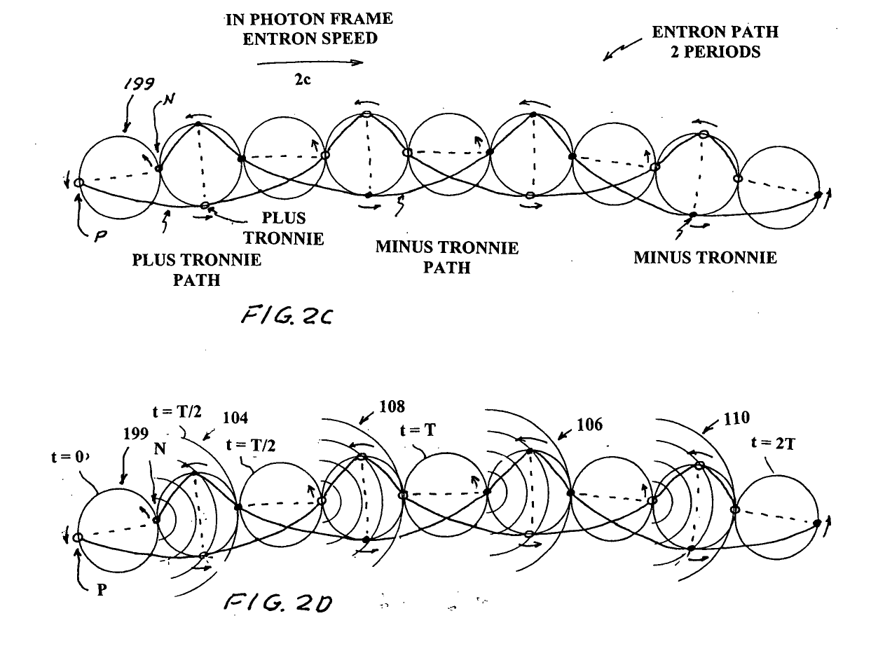

Entrons are the basic mass-energy quantum of our Universe. Every entron is comprised to one plus tronnie and one minus tronnie. Each tronnie is traveling at a speed of 1.57 c (π/2 times the speed of light) in a circle. The circle can be any size from 1.46×10⁻¹⁸ m to at least a few centimeters, the largest entron being about 10¹⁶ larger than the smallest. Once the two tronnies have been joined together to form an entron, they together can resist other forces. (Remember a tronnie by itself cannot resist any force at all since it has no mass.) Having the ability to resist forces is what “mass” is. So I have shown that two tronnies each with an electric charge and no mass can join together to produce a stable configuration that has mass and energy but no net charge. I have shown how mass can be created from two tronnies which, as we have pointed out above, are in reality two haves of nothing. I have shown how mass can be created from two haves of nothing. FIGS. 2A and 2B are snapshot drawings of an entron. The plus tronnie P is shown at 200 and the minus tronnie N is shown at 202. Plus tronnie P at location 200 is being repelled by its own Coulomb force wave that left itself at location 202 when plus tronnie P was at location 202. Plus tronnie P is being attracted by a Coulomb force wave that left minus tronnie N when minus tronnie N was at location 204. These two Coulomb forces when integrated around the circle are inversely proportional to the distance traveled by the two Coulomb force waves. The distance traveled by the repulsive force wave is d′ (the diameter of the circle) and the distance traveled by the attractive force wave is 0.5946 d′ so the attractive force is substantially greater than the repulsive force. However the attractive force is split between a diametrical force component and a tangential force component and the component of the attractive force in the diametrical direction is reduced by the cosine of angle α as shown in FIG. 2B. The angle α is 53.515 degrees and the cosine of 53.515 degrees is 0.5946. Therefore, the component of the attractive force on plus tronnie P at location 201 from minus tronnie N in the diametrical direction is exactly equal to the repulsive force on plus tronnie P from itself from directly across the circle from location 202. The tangential attractive force from minus tronnie N is not cancelled and keeps plus tronnie P circling at 1.57 c along the circumference the circle which is completely stable and self-sustaining so that the entron may exist in this configuration for billions of years. (Detailed calculations of these forces are provided in the following section entitled “Forces and Energy”.)

### Forces and Energy

The FIG. 2B drawing shows the forces acting within an entron at only one instant of time. If we add up all of the similar instances around the circumference of the entron's circle (this is called integrating around the circle), we see that the forces (having force units such as newtons) when integrated (i.e. added up) over the distance around the circle become units of energy (having energy units such as joules or electron volts).

### Integrating Around the Entron Circle

As explained in the Background section, the formula for the Coulomb force is:

$$F = k \frac{{Q}_{1} {Q}_{2}}{{f}^{2}} \qquad ( 4 )$$

However, this equation assumes that the two charges are stationary. Our charges (the tronnies) are each traveling at speeds of 471,000,000 m/s around the circumference of entron 199, but relative to each other they appear to be stationary. Each one is continuously intersecting its own repulsive Coulomb force wave and an attractive Coulomb force wave from the other tronnie. They are always separated from each other and their own previous positions by the same distances. For the repulsive force, that distance is the diameter of the entron circle, d′ and for the attractive force that distance is b′=0.59461d′ as shown in FIG. 2B.

So the incremental repulsive force on tronnie P is:

$$Incremental Repulsive Force , F = \frac{k {Q}_{1} {Q}_{2}}{{( {d}^{′} )}^{2}}$$

The incremental attractive force on tronnie P is:

$$Incremental Attractive Force , F = \frac{k {Q}_{1} {Q}_{2}}{{( 0.59461 {d}^{′} )}^{2}}$$

These incremental forces are in force units (newtons, N). To get the total integrated force for one cycle of the entron we multiply each of these values by the distance around circles defined by the distance separating each of the two tronnies times π (i.e. 3.1416). This is πd′ in the case of the repulsive force. It is 0.59461πd′ in the case of the attractive force. So the integrated repulsive force and the integrated attractive force on tronnie P is:

$$\begin{matrix}Integrated Repulsive Force , {F}_{1} = \frac{π {d}^{′} k {Q}_{1} {Q}_{2}}{{( {d}^{′} )}^{2}} \\ = \frac{π k {Q}_{1} {Q}_{2}}{{d}^{′}}\end{matrix} \qquad ( 5 )$$

$$\begin{matrix}Integrated Attractive Force , {F}_{1} = \frac{0.59461 π {d}^{′} k {Q}_{1} {Q}_{2}}{{( 0.59461 {d}^{′} )}^{2}} \\ = \frac{π k {Q}_{1} {Q}_{2}}{0.59461 {d}^{′}}\end{matrix} \qquad ( 6 )$$

The Coulomb constant k is 8.99×10⁹ Nm²/C², π is 3.1416, Q₁ and Q₂ are each 1.602×10⁻¹⁹ C and d′ has units of meters, so these integrated attractive and repulsive forces have units of energy, newton-meters (Nm) or joules (J).

As shown in FIG. 2A the integrated attractive force F_{IA} can be separated into two components, one in the direction of the diameter of entron circle 199 and the other in the direction of a tangent to circle 199 at location 200. The angle created by diameter d′ and the direction between location 200 and location 204 is shown on FIG. 2B as α and that angle is 53.515 degrees. The diametrical component of the attractive integrated force F_{IA} can be determined by multiplying F_{IA} by the cosine of α. The cosine of 53.515 is exactly equal to the ratio of the distance b′ to the diameter d′ of circle 199. Therefore the diametrical component of the integrated attractive force on tronnie P is:

$$\begin{matrix}{F}_{IADIA} = ( \frac{π k {Q}_{1} {Q}_{2}}{0.59461 {d}^{′}} ) cos ( {53.515}^{°} ) \\ = \frac{π k {Q}_{1} {Q}_{2}}{{d}^{′}}\end{matrix} \qquad ( 7 )$$

The reader can see that this diametrical component of the attractive integrated force, Equation (7) is exactly equal to the repulsive integrated force which is in the diametrical direction, Equation (5). Therefore, entron are basically stable as described above and may exist unchanged for billions of years.

The attractive integrated force acting on tronnie P in the tangential direction is:

$$\begin{matrix}{F}_{IATAN} = ( \frac{π k {Q}_{1} {Q}_{2}}{0.59461 {d}^{′}} ) sin {53.515}^{°} \\ = ( \frac{π k {Q}_{1} {Q}_{2}}{0.59461 {d}^{′}} ) 0.8040 \\ = 1.352 \frac{π k {Q}_{1} {Q}_{2}}{{d}^{′}}\end{matrix}$$

The same force is also acting on tronnie N so the total net attractive integrated force producing spin of entron 199 is:

$${F}_{IATAN} = 2.704 \frac{π k {Q}_{1} {Q}_{2}}{{d}^{′}}$$

Substituting values we get:

$${F}_{IATAN} = 2.704 \frac{3.1416 ( 8.99 \times {10}^{9} {Nm}^{2} \text{/} {C}^{2} ) {( 1.602 \times {10}^{- 19} C )}^{2}}{{d}^{′}} \\ \begin{matrix}{F}_{IATAN} = {E}_{e} \\ = 21.8 \times {10}^{- 29} {Nm}^{2} \text{/} {d}^{′} \\ = 21.8 \times {10}^{- 29} Jm \text{/} {d}^{′}\end{matrix} \qquad ( 8 )$$

According to the current version of the Ross Model the total attractive integrated tangential force F_{IATAN} represents the energy of the entron, Eₑ. Thus its energy is a function only of its diameter d′. Therefore if we know d′ we can calculate the entron's energy. Conversely if we know the entron energy we can calculate its diameter. Since the entron's energy is equal to the energy of a photon that the entron would create if released as a photon, once we know the energy of the entron we can calculate its mass using Equation (3), Professor Einstein's famous equation:

E=mc² or m=E/c²

The circle 300 can have almost any size and as indicted by Equation (6), the energy of the entron is inversely proportional to the diameter of the entron circle. The smaller the circles, the greater are the integrated forces and the greater are the energies and masses of the entrons. According to the Ross Model the smallest entron with the highest energy is the neutrino entron with a diameter of 1.46×10⁻¹⁸ meters. Its energy is about 931 MeV. Radio wave entrons can have diameters in the range of 0.136 meters (13.6 cm) with energies in the range of about 1×10⁻¹⁴ MeV. Thus, the range of entron sizes is enormous with the largest entron being 100 thousand trillion (1×10¹⁷) times larger than the smallest entron. And the smallest entrons have energies and masses of more than 100 thousand trillion times larger than the largest entrons. See Table V in the next section for specific examples.

### Entrons are Almost Everything

Entrons like tronnies are creatures of the Ross Model. They were unknown before I discovered them in a thought experiment in 2005 (just 100 years after Albert Einstein published his Special Theory of Relativity). Entrons are the source of all heat, electric and radiation energy in our Universe. In addition these entrons represent more than 99 percent of the mass of our Universe. (The only other masses in our Universe are the masses of electrons and positrons.) Entrons trapped in matter provide the matter its heat and determine its temperature. Entrons can be radiated away from matter in the form of photons leaving the matter cooler. Entrons captured by electrons provide the electric energy (the voltage) that drives all of our electrical equipment and devices. Entrons are the effective part of and carry all of the energy of the photons. A single entron, the neutrino entron, provides almost all of the mass of each proton and in the form of a photon all of the gravity of our Universe. Entrons in photons are captured by the molecules in leaves of plants that directly or indirectly produce the food that ultimately provides the energy that allows our bodies to operate. Photons are described in the next section.

### Photons

Photons are electromagnetic radiation. Each type of photon is identified by its wavelength. The range of photons corresponds to the range of entrons and is very large as shown by Table V. This range of photons is referred to as the electromagnetic spectrum. The various types of photons are identified by their wavelengths in meters and their energies which may be in joules (J) or electron volts (eV). Visible light photons allow us to see. Visible light photons are only a very small part of the electromagnetic spectrum as indicated by the Table V. The various types of photons in the electromagnetic spectrum (starting with the longest wavelengths and lowest energies) are radio wave photons, microwave photons, millimeter wave photons, infrared photons, visible light photons, ultraviolet photons, x-ray photons, gamma ray photons and neutrino photons. All of these types of photons are very well known except for the neutrino photon which is not known at all except by people familiar with the Ross Model. All photons travel through Coulombic fields at the speed of light.

According to the Ross Model each photon is comprised of only one entron which represents all of the mass and energy of the photon. As explained in the background section, Equation (1), the energy of photons is determined by its wavelength. Substituting values for h and c we get for the photon energy Eₚ:

Eₚ=hc/λ=(6.626×10⁻³⁴ Js)(3×10⁸ m/s)=1.9878×10⁻²⁷ JM/λ (9)

This provides us with a simple method of determining the diameter of the entron in terms of photon wavelength. Equation (8) gives the energy of the entron in terms of its diameter. Equation (8) is:

Eₑ=21.8×10⁻²⁹ Jm/d′

So we can merely equate the two energy values, Equations (8) and (9), to determine the entron diameter, d′ in terms of the wavelength λ of the photon for which the entron is providing the energy and mass. So:

$${E}_{e} = {E}_{p}$$

$$21.8 \times {10}^{- 29} Jm \text{/} {d}^{′} = 1.9878 \times {10}^{- 27} Jm \text{/} λ$$

$$So \text{:}$$

$$\begin{matrix}{d}^{′} = \frac{21.8 \times {10}^{- 29} Jm \text{/} {d}^{′}}{1.9878 \times {10}^{- 27} Jm \text{/} {d}^{′}} \\ = 0.001097 λ \\ = 1.097 \times {10}^{- 3} λ\end{matrix}$$

$$and$$

$$λ = 911.6 {d}^{′} .$$

According to the Ross Model all of the energy of every photon is represented by a single entron which in each case is two tronnies circling in a circle as described in the preceding section having a diameter which is about 911.6 times smaller than the wavelength of the photon that the entron is a part of.

TABLE V
Typical Photons

| | Photon-Entron | Photon | Entron |
|---|---|---|---|
| | Energy | Wavelength | Diameter |
| Photon | (eV) | (m) | (m) |
| Radio Wave Photons | 1 × 10⁻⁸ | 1.24 × 10² | 1.36 × 10⁻¹ |
| Microwave Photons | 1.02 × 10⁻⁵ | 1.21 × 10⁻¹ | 1.32 × 10⁻⁴ |
| Millimeter Wave Photons | 3.07 × 10⁻⁴ | 4.0 × 10⁻³ | 4.39 × 10⁻⁶ |
| Near Infrared Photon | 0.124 | 1.0 × 10⁻⁵ | 1.10 × 10⁻⁸ |
| Visible Light Photons | 2.29 | 5.4 × 10⁻⁷ | 5.92 × 10⁻¹⁰ |
| (Green) | | | |
| Ultraviolet Light Photons | 13.5 | 9.18 × 10⁻⁸ | 1.01 × 10⁻¹⁰ |
| X-Ray Photons | 12.4 × 10³ | 1.0 × 10⁻¹⁰ | 1.10 × 10⁻¹³ |
| Gamma Ray Photon | 7.40 × 10⁵ | 1.66 × 10⁻¹² | 1.82 × 10⁻¹⁵ |
| Gamma Ray Photon | 1.02 × 10⁶ | 1.23 × 10⁻¹² | 1.34 × 10⁻¹⁵ |
| Gamma Ray Photon | 8.37 × 10⁶ | 1.48 × 10⁻¹³ | 1.62 × 10⁻¹⁶ |
| Neutrino Photon | 9.31 × 10⁸ | 1.36 × 10⁻¹⁵ | 1.46 × 10⁻¹⁸ |

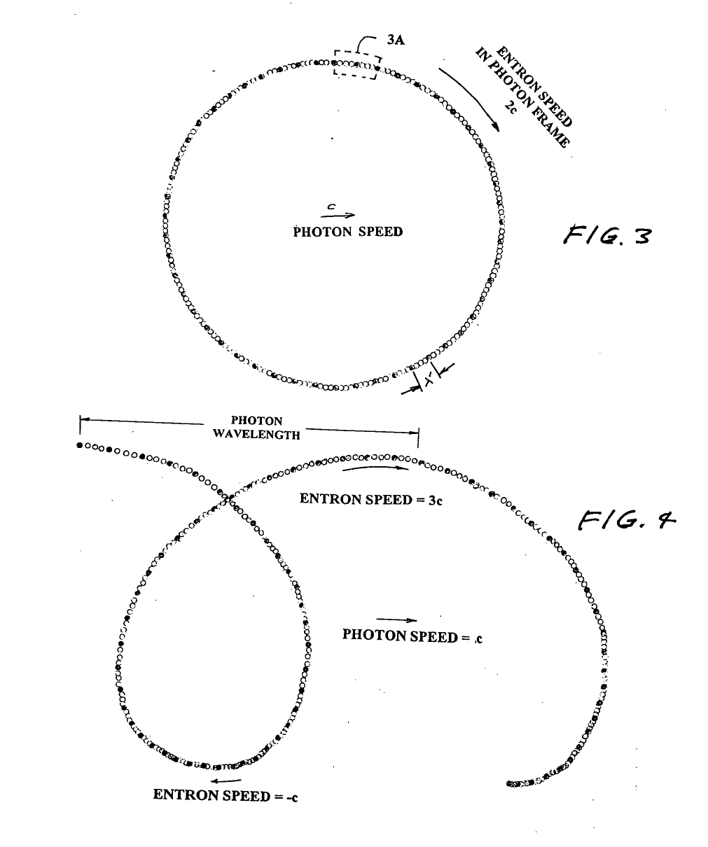

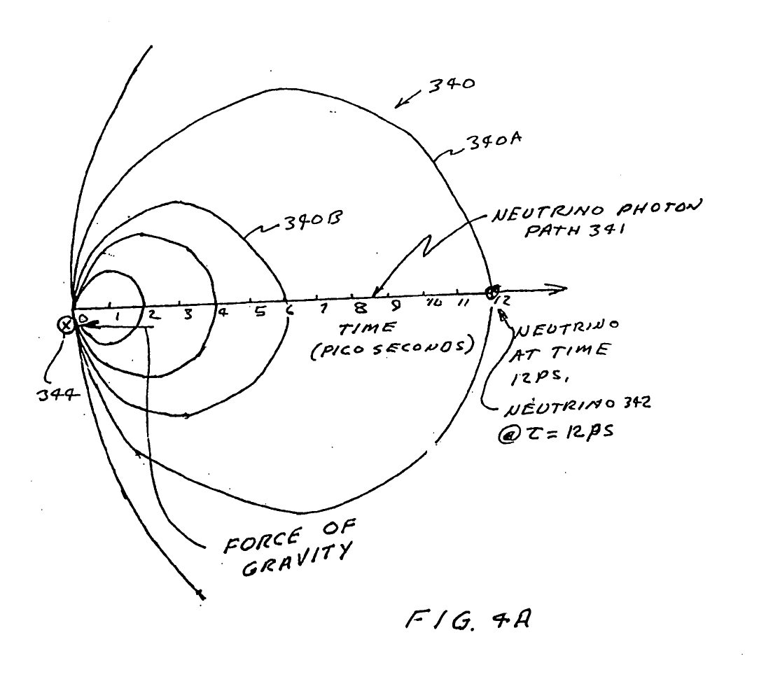

Once entrons which have been trapped in matter are released from the matter the electric forces expanding out from the two tronnies making up the entron force the entron into a complicated path. The entron itself keeps its circular configuration. However, both tronnies in the entron are attempting to stay ahead of their own electric force waves as they are leap-frogging each other as shown in FIGS. 3A and 3B. This results in the entron being propelled at twice the speed of light (2 c=6×10⁸ m/s) as shown in FIG. 3A. The entron does not travel in a straight line at a speed of 2 c. Since the electric force from each of the two tronnies is traveling at a speed of c (c=3×10⁸ m/s), over any distance that is large compared to the diameter of the entron, the entron wants to travel at a speed of c. How can the entron travel at a speed of 2 c and also travel at a speed of c? Easy, it just travels in a circle at a speed of 2 c as shown in FIG. 3C defining a photon circle and the circle travels at a speed of c. The net effect is shown in FIG. 4.

The time for a complete circle of the entron in a photon is t=λ/c. This in time units is called the photon “period”. The time for each of the two tronnies to make a complete circle within the entron is t′=2d′/c. This is the entron period. In one photon period, t=λ/c, the entron will make a number of cycles N=t/t′=λ/2d′=911.6d′/2d′=455.8 cycles.

Albert Einstein in developing his special theory of relativity wondered what a photon would look like if he could have caught up with it and observed it. He did not follow up on his question possibility because he erroneously concluded that nothing with mass could go as fast as a photon, i.e. at the speed of light. If he had followed up on his question he might have concluded that the photon in its own frame of reference would look like FIG. 3. He would have been correct. He might have also correctly concluded that the entron goes faster than the speed of light (up to three times the speed of light, see FIG. 4).

With the entron circling at a speed of two times the speed of light also proceeds in a forward direction at the speed of light (c=3×10⁸ m/s). The entron path looks like the drawing in FIG. 4. This path looks somewhat like the path that a small light would describe if it were mounted on the rim of a wagon wheel rolling across the prairie at night. The perfect analogy would be a light on the rim of circular frame where the light on the rim is traveling at twice the speed of the wagon instead of only 1.57 times the speed of the wagon which is the normal speed of a point on the rim. Remember, the two tronnies of the entron are continuing to travel in their own circle which has a diameter that is 455.8 times smaller than the diameter of the photon circle.

From the view of a stationary person watching the photon pass by the entron actually travels backwards at a speed equal to the speed of light at one point during each cycle of the photon as shown in FIG. 4. Its fastest speed as indicated above is 3 c and its average speed in the direction of the photon travel is c, all as shown in FIG. 4.

When entrons radiate away from matter in the form of photons the wavelength of the photon is determined by the energy of the entron which in turn is determined by the diameter of the entron. The equation explaining this relationship has been derived above:

λ=911.6 d′

where λ is the photon wavelength and d′ is the entron diameter. The energy of the photon Eₚ is the same as the energy of its entron Eₑ, which is according to Equation (8):

Eₚ=Eₑ=21.8×10⁻²⁹ Jm/d′

Conversely, when photons are absorbed in matter (such as in the body of a pretty girl lying half-naked on the beach soaking up the photons from the sun) the entrons that were the energy and mass of the photons then become integral parts of her body. When she is lying on the beach in the sunlight, she is absorbing visible, ultraviolet and infrared photons and her warm body is radiating mostly infrared photons and millimeter wave photons. Most of the photons absorbed by her body are absorbed as heat energy warming up her body. Photons radiating out from her body carry heat energy out of her body. Much of the visible light from the sun reflects off her body and bathing suit allowing people to see her and her bathing suit. Entrons in matter may exist in the form of heat energy increasing the temperature of the matter or it could be absorbed chemically and become a part of a new molecule in the matter. For example some of the ultraviolet light absorbed in your skin is used by her skin cells to produce vitamin D. Entrons of sunlight photons absorbed in leaves of plants are used (along with carbon dioxide in the air and water atoms and molecules from the soil) by the plants to produce organic molecules allowing the plant to grow. Each of those entrons carries a small amount of energy. When a person consumes portions of the plant directly (such as when she eats a carrot) or indirectly (such as when she drinks a glass of milk) those entrons become available to provide energy for her legs to propel her across a tennis court, a soccer field or a golf course.

### The Neutrino Photon and the Neutrino Entron

An extremely important photon according to the Ross Model is the neutrino photon and an extremely important entron is the neutrino entron. As with all other photons the neutrino photon is an entron (in this case the neutrino entron) traveling in a circle at a speed of 2 c and forward at the speed of c (the speed of light) in a path as shown in FIG. 4. As shown in Table V the neutrino entron has a diameter of 1.46×10⁻¹⁸ m, a mass of 1.66×10⁻²⁷ kg and an energy of 9.31×10⁸ eV (1.492×10⁻¹⁰ J). The neutrino photon has a wavelength of 1.32×10⁻¹⁵ m, and the same mass and energy as the neutrino entron.

The individual neutrino entrons as explained above have a tiny mass of 1.66×10⁻²⁷ kg, but as we will see, nearly all of the mass of our Universe is provided by these tiny things. This in large part is because nearly all of the mass of our Universe is represented by protons and nearly all of the mass of each proton is represented by a single neutrino entron which has been captured by a naked negative electron with a mass of only 9.109×10⁻³¹ kg. The proton also includes two positrons to give it a net positive charge of plus one to go with its 1.66×10⁻²⁷ kg neutrino entron mass and the mass of two positrons and one electron which is a total of only 0.0027×10⁻²⁷ kg.

Neutrino photons are produced in Black Holes with the destruction of protons and the release of the neutrino entron in each proton. These neutrino entrons spread out form the Black Holes at the speed of light as neutrino photons to provide the gravity of the galaxy associated with each Black Hole. This gravity in turn provides a steady stream of matter flowing into the Black Holes which is broken down into protons, electrons and entrons and as explained above the protons are ultimately destroyed in the Black Holes to release more entrons to keep the process going for billions of years.

Neutrino photons are extremely penetrating. Most of them that illuminate objects such as our earth and the sun pass right through unimpeded and continue on through our Universe for billions of years until they reach the cold plasma shell that surrounds the rest of our Universe. The cold plasma shell of our Universe is described below in the section entitled “The Cold Plasma Shell of our Universe”. The shell is many light years thick and the entron of each neutrino photon is ultimately captured by a naked electron which causes the entron-electron pair to circle extremely rapidly in a tiny circle and the negatively charged circling pair quickly captures two positrons to become a high speed naked proton. In time the high speed naked proton will capture sufficient gamma ray entrons to slow it down enough to become a hydrogen nuclei which in turn captures an electron to become a hydrogen atom that in turn will help form new stars at the outer edge of our Universe to continue its growth and expansion.

### The Size of Other Photons and Entrons

This preferred model proposes an entron diameter of λ/101.7 where λ is the wavelength of the photon that the entron is a part of. And the width of the photon path is 2λ/π=0.6366λ. So we can visualize the size of any photon. Table I lists some typical photons and their entrons by their wavelengths, masses, energies and diameters or widths. Table I can be extended to photons with other wavelengths using the following relationships:

Entron-Photon Energy: E=hc/λ=(4.136×10⁻¹⁵ eVs)(3×10⁸ m/s)/λ

=1.2408×10⁻⁶ eVm)/λ, or

=(6.626×10⁻³⁴ Js)(3×10⁸ m/s)/λ

=1.9878×10⁻²⁵ Jm/λ

Entron Diameter: d′=λ/911.6=(1.361×10⁻⁹ eVm)/E=2.18×10⁻²⁸ Jm/E

Photon Width: d=2λ/π0.6366λ

Entron-Photon Mass: m=E/c²=E/(9×10¹⁶ m²/s²)

TABLE VIII

| | | Entron-Photon | Entron | Photon | Entron-Photon | Entron-Photon |
|---|---|---|---|---|---|---|
| | Photon | Energy | Diameter | Width | Energy | Mass |
| | Wavelength λ | E = hc/λ | d′ = λ/911.6 | d = 0.6366λ | E = hc/λ | m = E/c² |
| Photon | (m) | (eV) | (m) | (m) | (J) | (Kg) |
| Radio Wave | 1.24 × 10³ | 1 × 10⁻⁸ | 1.36 | 0.79 × 10³ | 1.6 × 10⁻²⁸ | 1.78 × 10⁻⁴⁵ |
| Microwave (oven) | 12.1 × 10⁻² | 1.02 × 10⁻⁵ | 1.33 × 10⁻⁴ | 7.70 × 10⁻² | 1.64 × 10⁻²⁴ | 1.82 × 10⁻⁴¹ |
| 75 GHz mm wave | 4 × 10⁻³ | 3.07 × 10⁻⁴ | 4.38 × 10⁻⁶ | 2.5 × 10⁻³ | 4.96 × 10⁻²³ | 5.5 × 10⁻⁴⁰ |
| Near IR Photon | 1 × 10⁻⁵ | 1.24 × 10⁻¹ | 1.09 × 10⁻⁸ | 6.37 × 10⁻⁶ | 1.98 × 10⁻²⁰ | 2.2 × 10⁻³⁷ |
| Green Light Photon | 5.4 × 10⁻⁷ | 2.29 | 5.92 × 10⁻¹⁰ | 3.43 × 10⁻⁷ | 3.68 × 10⁻¹⁹ | 4.09 × 10⁻³⁶ |
| 13.5 eV ultraviolet | 9.18 × 10⁻⁸ | 1.35 × 10 | 1.01 × 10⁻¹⁰ | 5.84 × 10⁻⁸ | 2.16 × 10⁻¹⁸ | 2.4 × 10⁻³⁵ |
| X-Ray (12.4 KeV) | 1 × 10⁻¹⁰ | 1.24 × 10⁴ | 1.09 × 10⁻¹³ | 6.37 × 10⁻¹¹ | 1.97 × 10⁻¹⁵ | 2.19 × 10⁻³² |
| Gamma (0.74 MeV) | 1.66 × 10⁻¹² | 7.4 × 10⁵ | 1.82 × 10⁻¹⁵ | 1.06 × 10⁻¹² | 1.19 × 10⁻¹³ | 1.21 × 10⁻³⁰ |
| Gamma (1.02 MeV) | 1.23 × 10⁻¹² | 1.02 × 10⁶ | 1.35 × 10⁻¹⁵ | 7.83 × 10⁻¹³ | 1.63 × 10⁻¹³ | 1.81 × 10⁻³⁰ |
| Gamma (1.5 MeV) | 8.27 × 10⁻¹³ | 1.5 × 10⁶ | 9.07 × 10⁻¹⁶ | 5.26 × 10⁻¹³ | 2.40 × 10⁻¹³ | 2.67 × 10⁻³⁰ |
| Neutrino Photon | 1.32 × 10⁻¹⁵ | 9.31 × 10⁸ | 1.45 × 10⁻¹⁸ | 8.4 × 10⁻¹⁶ | 1.5 × 10⁻¹⁰ | 1.67 × 10⁻²⁷ |

Note that the diameter of the 1.02 MeV entron is approximately the same size as the wavelength of the neutrino photon.

The Table I examples of photons demonstrate the tremendous range of photons. I will give a brief description of the examples I have listed:
The radio wave example is a big, very low energy photon, its wavelength is 1.24 kilometer. Its entron has a diameter of about 1.36 meters. These photons can penetrate non-metal walls.
The photons that heat our TV dinners in our microwave ovens have wavelengths of 0.12 meters (12 centimeters) and entrons with diameters equal to about 0.133 millimeters traveling in circles with a diameter of 7.7 cm. These photons cannot penetrate the metal grid in a typical microwave oven.
Our warm 98.6° F. (22.78° C.) bodies radiate infrared and millimeter wave photons. The millimeter wave wavelengths at of about 4 millimeters can pass through our clothing. The entrons of these photons (when they were warming our bodies, had diameters of about 4.3 microns (about one tenth the width of a human hair).
Our warm bodies also radiate infrared radiation at wavelengths of about 10 microns (with entron diameters of about 0.01 microns) which is trapped in our clothing. These photons are a little too long for our eyes to detect.
But our eyes are extremely sensitive to visible light photons, peaking in green light at wavelengths of 0.54 microns with entron diameters (about 0.592 nanometers) about the size of a large atom and smaller than the molecules in our retinas.
The 13.5 eV entron of the ultraviolet photon with entron diameters of about 0.1 nanometers slightly larger than the smallest atoms can provide enough energy to an electron orbiting a hydrogen atom to allow it to escape from the hydrogen nucleus but entrons of these photons are too small for the molecules in our eyes to detect.
The 12.4 keV x-ray photon has a wavelengths of 0.1 nanometers (one tenth of a billionth of a meter) and its entron diameter at about 1×10⁻¹³ m (about 100 times smaller than a small atom) is a lot smaller than atoms and a lot larger than atomic nuclei, which helps explain why x-rays come from atoms and not nuclei.
The 0.74 MeV gamma ray photon, with an entron diameter of 1.82×10⁻¹⁵ m (slightly larger than the size of a proton which, according to the Ross Model is about 1.67×10⁻¹⁵ m) but smaller than most atomic nuclei is released along with an electron when a neutron decays to a proton.
The 1.02 MeV gamma ray photon is the minimum energy photon that can participate in pair production. Its entron has a diameter of about 1.35×10⁻¹⁵ m (slightly larger than a proton). The entron's diameter is equal to the wavelength of a neutrino photon. As we will learn later, it takes this 1.02 MeV entron and two other entrons to make a pair of electrons.
The 1.5 MeV gamma ray photon represents a photon energy larger than 99 percent of gamma ray photons released from radioactive nuclei. Its entron would be 9.07×10⁻¹⁶ little larger than the components of a proton (about 0.835×10⁻¹⁶ m), but smaller than the proton.

Lastly, the 931 MeV neutrino photon is a most important photon. Its entron has a diameter of 1.45×10⁻¹⁸, about 1000 times smaller than a proton, and which is the same size as the components of the naked electron and the naked positron. This entron provides a proton with almost all of its mass and according to the Ross Model, these photons are be released in black holes when protons are destroyed to provide the gravity of our Universe.

### Tronnies of Entrons can Change Partners to Make New Entrons

An electron can capture more than one entron at the same time and when that happens the energies of all of the entrons are additive. An electron can capture a large number of low energy entrons to greatly increase its electric energy. (An example of this is seen when someone put a metal part in a microwave oven. Microwave photons have very low energies (about 1.02×10⁻⁵ eV as shown in Table I). The energies of the conduction electrons of the metal are almost instantly increased to energies high enough to vaporize the metal. In addition the tronnies of captured entrons can change partners so that a very low energy (very large diameter) entron and a very high energy (very small diameter) entron are both captured by a single electron, the four tronnies of the two entrons could change partners to produce two identical new entrons with energies half-way between the two original entrons. Total energy is always conserved.

### The Cold Plasma Shell of Our Universe

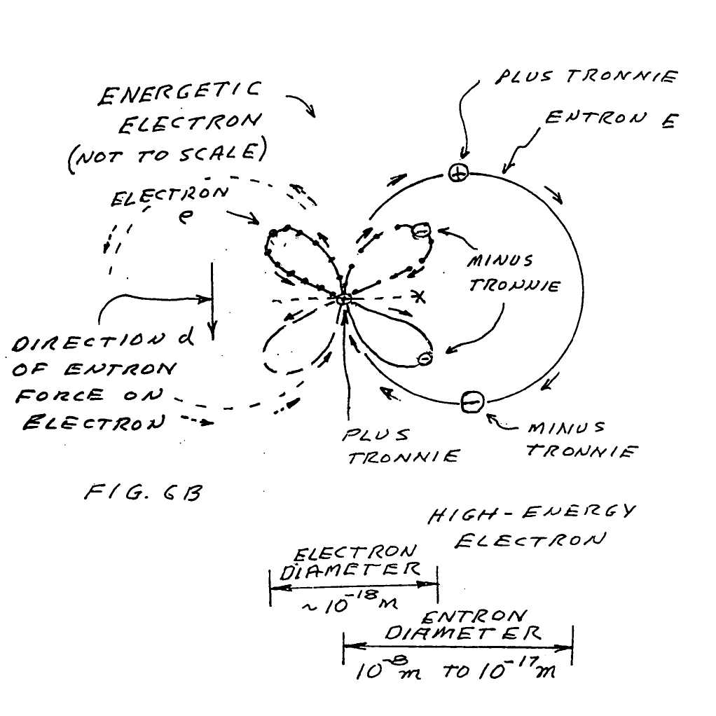

According to preferred embodiments of the present invention our Universe is surrounded by a cold plasma shell (see FIG. 6). That cold plasma shell according to the Ross Model is comprised mostly of naked electrons and an equal number of naked positrons most of which are traveling at their natural velocity of 2.18×10⁶ m/s. There are also be in this cold plasma shell some naked protons traveling at their natural velocity. Within the shell near the inside surface, there are a large variety of entrons, energetic electrons and positrons and hydrogen atoms. The cold plasma shell reflects almost all photons except neutrino photons which are absorbed in the shell. Most of the reflected photons have been reflected back and forth between the inside surface of the shell since soon after the Big Bang. These reflected photons have been red shifted due to the Doppler effects from reflection off the ever expanding shell. So this cosmic background radiation has become colder and colder during the 15 billion years since the Big Bang.

### The Big Bang

The Big Bang that was the birth of our Universe destroyed all or substantially all of the protons of the universe that preceded our Universe. The first group of photons out of the Black Hole traveled at the speed of light but they traveled in a grid of Coulomb forces from neutrino photons that had been left over from the previous universe that were traveling out from the Black Hole at the speed of light. As a result the photons were traveling at twice the speed of light. The second group of photons traveled in a grid of Coulomb forces left by the first group of photons so they traveled at three times the speed of light. The third group traveled in a Coulomb force field left by the photons of the second group which was moving our at three time the speed of light so this third group of photons traveled out at four times the speed of light. The result was an expansion of billions of light years in a fraction of a second of all of the contents of the basketball size Black Hole that exploded in the Big Bang. After this almost instantaneous expansion our Universe was a fairly uniform combination of entrons having energies ranging from approximately zero to neutrino entron energies. Whenever a neutrino entron combined with a 1.02 MeV entron and a low energy entron, the result was pair production of an electron and a positron. So an enormous population of electrons and positrons was produced. Many positrons and electrons combined producing 0.511 MeV photons, but neutrino entrons also were captured by electrons and positrons. When this happened a very high energy electron or positron would be produced. If it were a very high energy electron, the very high energy electron would immediately attract two positrons to form a proton. If it were a very high energy positron, the very high energy positron would immediately attract two electrons to form an anti-proton. Protons and anti-protons would combine to annihilate each other. Gradually however more protons were produced than anti-protons. This lead to a reduction of positrons relative to electrons in our Universe. Since there were more free electrons as compared to free positrons, it was more likely that a neutrino entron would combine with an electron than with a positron; therefore, many more protons were produce as compared to anti-protons. During this period some of the protons would combine, four with two electrons, to form alpha particles which would later on collect two more electrons in orbit to become helium atoms.

### Electrons

According to the Ross Model there are two types of electrons, “naked electrons” and “energetic electrons”. An energetic electron is a naked electron that has captured at least one entron.

### Naked Electrons

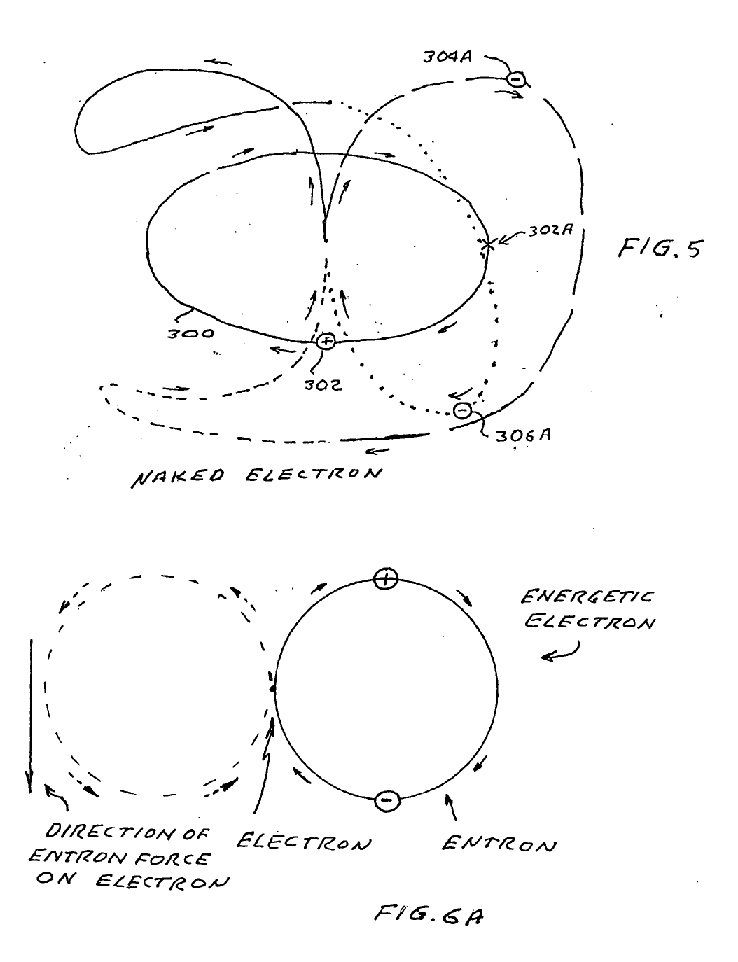

FIG. 5 is a snapshot drawing of a naked electron. Naked electrons are comprised of three tronnies, one plus tronnie shown at 302 and two minus tronnies shown at 304A and 306A. Arrows show the paths of the three tronnies during one electron cycle. The plus tronnie travels in circle 300 in the direction shown by little arrows. The diameter of the circle is 1.46×10⁻¹⁸ m and the tronnie is traveling around the circle at a velocity of 1.57 c. The two minus tronnies also travel in a circle with a diameter of 1.46×10⁻¹⁸ m but that circle also follows the plus tronnie around its circle always one-forth of an electron period behind the plus tronnie. The time for a complete cycle of the electron (its period) is 9.6×10⁻²⁷ second. Notice that each of the two minus tronnies pass through the center of plus tronnie's circle once each cycle. This provides a net upward force on the plus tronnie giving the naked electron a natural velocity which the Ross Model estimates at 2.18×10⁶ meters per second. Since the electron has a mass of 9.1×10⁻³ kg, the naked electron according to the Ross Model has a natural kinetic energy (E=½ mv²) of 2.16×10⁻¹⁸ Jor 13.5 eV.

The positron is the anti-particle of the electron. Naked positrons are just like the naked electrons except the center tronnie is a minus tronnie and the two tronnies that are circling behind it are plus tronnies. Naked positrons also have a natural velocity of 2.18×10⁻⁶ m/s and kinetic energy of 2.16×10⁻¹⁸ J or 13.5 eV.

### Energetic Electrons and Positrons

FIG. 5A is a drawing of a low-energy energetic electron. This is a naked electron that has captured an entron. The two tronnies, of the captured entron, circle through the center of the plus tronnie's circle in the electron. But the entron does not revolve with the plus tronnie as do the two minus tronnies of the electron. The Coulomb forces of the two tronnies in the entron apply a net force on the three tronnies of the naked electron and that net force is opposite the natural direction of the naked electron. Therefore, if the captured entron has energy of less than 13.5 eV, it actually slows down the naked electron. An entron with an energy exactly equal to the kinetic energy of the naked electron (assumed to be 13.5 eV) reduces the electron velocity to zero. A naked electron (zero energy) orbiting a hydrogen atom (i.e. one traveling at its natural velocity of 2.18×10⁶ m/s} orbits at a distance of about 0.529×10⁻¹⁰ m (called the Bohr radius). An electron orbiting a hydrogen nucleus with a velocity close to zero would be orbiting at a very large radius (mathematically an infinite radius which implies that the electron is separated from the hydrogen nucleus). FIG. 5B is a drawing of a high-energy electron. If the captured entron has energy greater than 13.5 eV, the entron drives the electron in a direction opposite its natural direction. The greater the energy of the entron (above 13.5 eV), the greater is the velocity of the electron. The total energy E_{T} of an electron is its natural energy E_{N} minus its entron energy Eₑ. Mathematically I write this relationship as:

E_{T}=E_{N}−Eₑ.

The total energy is the difference because the entron is trying to drive the election in a direction opposite its natural direction.

The kinetic energy KE of any object with mass m that is moving with velocity v is:

KE=(½)mv².

If we set the total energy E_{T} of an electron equal to its kinetic energy KE, we have:

K_{T}=KE=E_{N}−Eₑ=(½)mv².

But the mass of the electron is the sum of the mass of the naked electron m_{N} plus the mass of the entron mₑ that is giving the electron its electric energy. So:

E_{N}−Ee=(½)(m_{N}+mₑ)v².

Therefore, we can calculate the velocity of the energetic electron as a function of entron energy and mass since the mass of the naked electron is known and constant and we have specified the kinetic energy of the naked electron as 2.16×10⁻¹⁸ J:

$$\begin{matrix}v = \sqrt{\frac{2 ( {E}_{N} - {E}_{e} )}{{m}_{N} + {m}_{e}} =} \\ = \sqrt{\frac{2 [ ( 2.16 \times {10}^{- 18} {kgm}^{2} / {s}^{2} ) - {E}_{e}}{( 9.1 \times {10}^{- 31} kg ) + {m}_{e}}}\end{matrix} \qquad ( 8 )$$

where 2.16×10⁻¹⁸ kgm²/s² is the kinetic energy E_{N} of the naked electron, 9.1×10⁻³¹ kg is the mass m_{N} of the naked electron. When energy and mass of the entron is substantially less than the energy and mass of the naked electron, the equation reduces to v=2.18×10⁶ M/s. When the energy and the mass of the entron are much greater than that for the naked electron, the equation reduces to:

$$\begin{matrix}v = \sqrt{\frac{2 {E}_{e}}{{m}_{e}}} \\ = \sqrt{\frac{2 {m}_{e} {c}^{2}}{{m}_{e}}} \\ = 1.414 c\end{matrix} \qquad ( 9 )$$

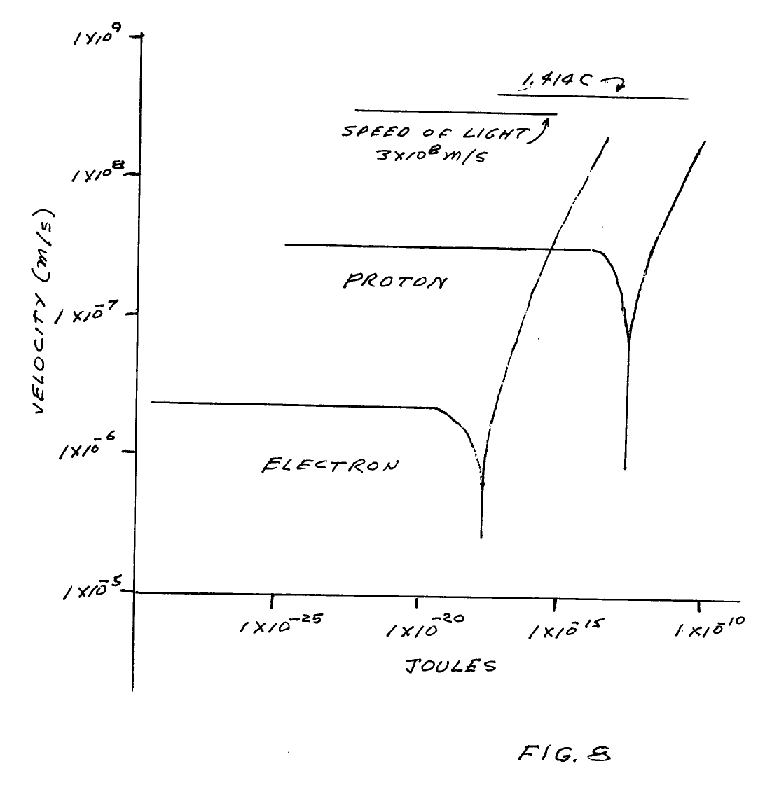

When the energy of the enton is equal to the kinetic energy of the naked electron, assumed to be 13.5 eV (2.16×10⁻¹⁸ joules), the velocity of the electron zero. A plot of the energetic electron velocity as a function of entron energy between 10⁻³⁰ J to 10⁻⁵ J is provided in FIG. 8. The reader will notice that at low entron energies the velocity of the energetic electron is constant at its natural velocity. The velocity decreases rapidly as the entron energy gets close to 2.16×10⁻¹⁸ joules then the velocity increases rapidly with increasing entron energies. However, an entron with energy of 1.014×10⁻¹⁵ J has the same mass as a naked electron so that an energetic electron energized with a 1.014×10⁻¹⁵ J (6.33 KeV) entron will have double the mass of a naked electron. At even higher entron energies the mass and energy of the naked electron becomes negligible compared to the mass and energy of the entron and the speed of the energetic electron gradually approaches 1.414 c as indicated by equation (9). However, the entron needed to increase the speed of an electron to the speed of light has an energy of 1×10⁻¹² J and a diameter of 2.18×10⁻¹⁶ m which is so small that the electron will want to follow the path of the tronnies of the entron. So it may not be possible to accelerate an electron in a straight line faster than the speed of light.

The reader should note that like Albert Einstein predicted the mass of the electron does increase with increasing velocity at velocities close to the speed of light. Entrons with energies equal to or greater than entrons of gamma rays have diameters similar to the diameter of protons so that those entrons may drive the electron in a circle so it may not be possible to drive an electron in a straight line at a speed greater than c. But the increases in the mass of the electron are due to the increased mass of the entron driving the electron and not due merely to the fact that the electron is approaching the speed of light. In fact, according to the Ross Model the actual mass of the naked electron portion of the energetic electron does not change at all no matter how fast it goes.

The discussion above regarding electrons is equally applicable to positrons (which are the antiparticle of the electron) except plus tronnies are substituted for minus tronnies.

### Protons

According to the Ross Model there are two types of protons, “naked protons” and “energetic protons”. An energetic proton is a naked proton that has captured at least one entron.

### Naked Protons

According to the Ross Model each naked proton is comprised of one very energetic and very massive electron and two naked positrons. This very energetic and massive electron is comprised of a naked electron (with a tiny mass of 9.109×10⁻³¹ kg, one neutrino entron (with a much greater mass of about 1.66×10⁻²⁷ kg). The two naked positrons, each has a tiny mass of 9.109×10⁻³¹ kg). According to the Ross Model the frequency of the neutrino entron is the same as that for the electron, and both are about the same size (about 1.46×10⁻¹⁸) so in the very unlikely event that they resonately intersect with each other, there is a good chance that the entron will be captured by the electron. (Or we may say that the electron is captured by the entron.) When that happens, the entron becomes a part of the electron and increases its velocity to a speed greater than the speed of light (actually 1.414 c as explained above). However, instead of driving the electron in a straight line as might be expected, the entron drives the electron in the entron's circle which, as explained above, is a circle with a diameter of 0.6366% where λ is the wavelength of the neutrino photon. The wavelength of the neutrino photon is 1.32×10⁻¹⁵ meters, so the diameter of the circle of the electron and its captured neutrino entron is 0.840×10⁻¹⁵ meters. If there are positrons in the vicinity of the rapidly spinning electron, they will be attracted to the center of the electrons circle. If one positron attempts to combine with the spinning electron the combination will be unstable; however, two positrons in combination with the spinning neutrino-entron-energized electron form the most stable composite particle in our Universe (i.e. the naked proton). The very energetic negative electron circling in a tiny circle at 1.414 c will exert a Coulombic force on itself across the diameter of the circle then additional boost will increase its speed to 1.57 c in order to add to the stability of the proton.

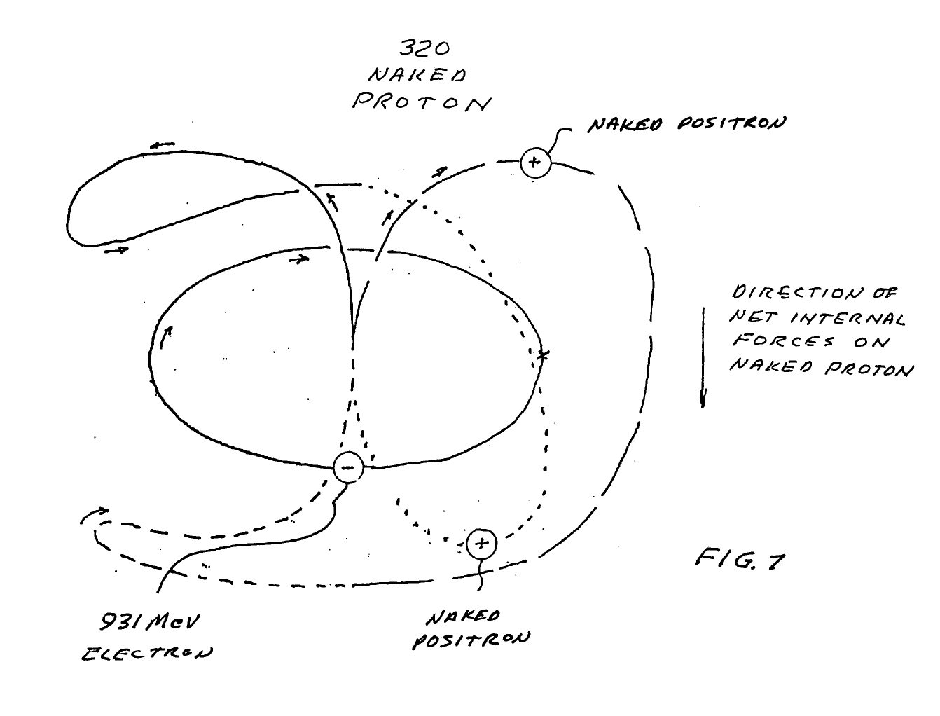

As will be explained in detail later in this specification, this creation of protons from the combination of an electron, two positrons and a neutrino entron is not currently happening on any significant scale, at least in the part of our Universe that is visible to us. This is because there are not many positrons available to complete the combination. However, in the very early seconds of after the Big Bang there were just about as many positrons as there were electrons and a huge flux of neutrino photons. So soon after the Big Bang enough protons were mass produced to create a universe. But we will get to the formation of our Universe later in this specification. FIG. 7 is a drawing showing the structure of the naked proton. Its structure is similar to the structure of the naked electron, but much larger. The circles of the two positrons have diameters equal to 0.834×10⁻¹⁵ meters, the same as the very energetic electron, which gives the proton a size of about 1.67×10⁻¹⁵ meters. The spin of the proton is the same as the spin of the electron, but the proton is about 1800 times more massive than the electron and about 580 times larger than the electron.

### The Proton's Mass is Concentrated in its Negative Electron

The reader should note at this point that more than 99 percent of the mass of each naked proton is concentrated in its negative electron circling faster than the speed of light in the center of the positively charged proton. The two positrons are circling the circular path of the electron one-fourth period behind the electron. The integrated Coulomb forces are in an exact balance which results in the proton's amazing stability. The fact that almost all of the mass of the proton is concentrated in the electron means the electron mostly determines the speed and direction of the proton based n coulomb forces external to the proton. Therefore the momentum direction and speed of the proton is basically the momentum, direction and speed of the proton's electron. Thus the naked proton is attracted to other protons which are positively charged. This explains how many protons each with a net positive charge of +1 can fit inside the nuclei of atoms. It is this feature of the Ross Model which explains why science does not need the fiction of the “strong force” to hold atomic nuclei together. The hydrogen nucleus, however, is a much different particle as compared to the naked proton. The hydrogen nucleus is a naked proton which has captured enough high energy electrons to reduce its momentum to approximately zero.

### Proton's Natural Velocity

The Ross Model assumes that the naked proton has a natural velocity, like the naked electron that is a fraction of the speed of light but the naked proton's speed is much faster than the speed of the naked electron. That speed is so fast that the naked proton cannot capture an electron to become a hydrogen atom. The naked proton must capture gamma ray entrons to slow down. To estimate the energy/mass of these gamma ray entrons needed by the naked proton to slow down to zero, the Ross Model compares the iron-56 atom to the most abundant hydrogen atom, hydrogen-1 which is comprised of one proton, one orbiting electron and according to the Ross Model, several gamma ray entrons in its nucleus. The Ross Model assumes that the proton of the hydrogen-1 atom has captured entrons having sufficient total energy to slow the proton down to a speed close to zero. The question is what is the mass and energy of these entrons?

The Ross Model assumes that the nucleus of all stable neutral atoms (other than hydrogen-1) are comprised of only protons, electrons and entrons in their nuclei with a number of orbiting electrons most of which are naked electrons. The number of electrons in the nucleus is equal to the difference between the number of protons in the nucleus and the number of electrons orbiting the nucleus. The charge neutral iron 56 nucleus may be an exception with no entrons in its nucleus. The mass of the hydrogen-1 atom (with one naked proton and an unknown number of captured entrons in the nucleus and one naked electron in orbit) is about 1.6735×10⁻²⁷ kg. The iron-56 isotope has the smallest mass-to-nucleon ratio of any stable isotope. The mass of the iron-56 isotope is about 92.8822×10⁻²⁷ kg. The Ross Model assumes that the iron-56 atom is comprised of 56 naked protons and 56 naked electrons (30 of which are in the nucleus and 26 are orbiting) and no entrons (or only entrons with insignificant mass/energy) within or outside the nucleus. With these assumptions the mass of one naked proton and one naked electron has a mass no greater than 1.6586×10⁻²⁷ kg (i.e. 92.8822×10⁻²⁷ kg/56). The difference in mass between the hydrogen 1 atom and the combination of one naked proton and one naked electron must be equal to the mass of the entrons in the hydrogen 1 nucleus. This leads in the Ross Model to an estimate that the entron or entrons in the nucleus of the hydrogen atom has (or have) a mass equal to or greater than 0.0149×10⁻²⁷ kg (i.e. 1.6735×10⁻²⁷ kg−1.6586×10⁻²⁷ kg). (The mass of the entron or entrons could be greater than 0.0149×10⁻²⁷ kg if the iron-56 nucleus contains one or more entrons with significant mass. This would mean that the naked proton mass is equal to or less than 1.6586×10⁻²⁷ kg.) The energy equivalent to this mass of 0.0149×10⁻²⁷ kg is about 1.341×10⁻¹² J (8.37 MeV).

A single entron with this energy would have a diameter of about 1.63×10⁻¹⁶ m. This diameter appears too small relative to the diameter of circle of the very energetic electron in the naked proton. Therefore, this preferred embodiment of the Ross Model proposes that the naked proton is slowed down to near zero speed with the capture of several entrons (probability about 5 to 10) with energies in the gamma range. The total energy of all of these entrons is estimated to be about 1.341×10⁻¹² J (8.37 MeV).

So now let us get back to estimating the natural, self-propulsion speed of the naked proton. This self-propulsion of the naked proton is due to the net Coulomb force applied by the two positrons in the naked proton as each of them pass upward through the center of the proton's high energy electron's circle. According to the Ross Model that force applied twice during each of the proton's 1.786×10²³ cycles per second, is sufficient to provide the naked proton with a natural velocity which is estimated using the equation:

E=½ mv²

where E is the total energy of the entrons needed to cancel the naked proton's natural kinetic energy. As explained above the Ross Model estimates the energy of the entron needed to slow down the naked proton to about zero speed at 1.341×10⁻¹² J. So the estimated mass of the naked proton is 1.6586×10⁻²⁷ kg, so the Ross Model's estimate of the natural velocity of the naked proton is:

$$\begin{matrix}υ = \sqrt{\frac{2 {E}_{e}}{{m}_{H}}} \\ = \sqrt{\frac{2 ( 1.341 \times {10}^{- 12} J )}{1.6586 \times {10}^{- 27} kg}} \\ = 4.02 \times {10}^{7} m \text{/} s\end{matrix}$$

which is a little faster than one-tenth of the speed of light.

The velocity of a hydrogen nuclei, with 8.366 MeV of captured entron energy (1.341×10⁻¹² J), is approximately zero. Entrons with energies greater than 8.37 MeV will propel the proton in directions opposite the naked proton's natural direction as explained above with respect to the electron. However, the higher entron energies mean larger entron masses which increase the mass of the proton. When entron energies become large compared to the mass of the naked proton the proton's speed levels off at 1.414 c as in the case of the energetic electron. The result is that the maximum velocity of a proton propelled with entron energy is the same as the maximum velocity of electrons propelled with entron energies, i.e. 1.414 c. FIG. 8 is a graph of electron and proton velocities as a function of captured entron energies. The formula is the same as Equation (8) except E_{N} is the natural energy of the naked proton and m_{N} is the mass of the naked proton.

TABLE VI
Energetic Electrons and Protons Mass

| Entron Energy | Entron Energy | Entron Mass | Energetic Electron | Energetic Proton |
|---|---|---|---|---|
| (joules) (kg-m²/s²) | (eV) | (J/c²) (kg) | Mass (kg) | Mass (kg) |
| zero | zero | zero | 9.1094 × 10⁻³¹ | 1.66 × 10⁻²⁷ |
| 1 × 10⁻³⁰ | 6.242 × 10⁻¹² | 1.1126 × 10⁻⁴⁷ | 9.1094 × 10⁻³¹ | 1.66 × 10⁻²⁷ |
| 1 × 10⁻²⁷ | 6.242 × 10⁻⁹ | 1.1126 × 10⁻⁴⁴ | 9.1094 × 10⁻³¹ | 1.66 × 10⁻²⁷ |
| 1 × 10⁻²⁴ | 6.242 × 10⁻⁶ | 1.1126 × 10⁻⁴¹ | 9.1094 × 10⁻³¹ | 1.66 × 10⁻²⁷ |
| 1 × 10⁻²¹ | 6.242 × 10⁻³ | 1.1126 × 10⁻³⁸ | 9.1094 × 10⁻³¹ | 1.66 × 10⁻²⁷ |
| 2.125 × 10⁻²¹ | 1.33 × 10⁻¹ | 2.36 × 10⁻³⁸ | 9.1094 × 10⁻³¹ | 1.66 × 10⁻²⁷ |
| 1 × 10⁻¹⁹ | 6.242 × 10⁻¹ | 1.1126 × 10⁻³⁶ | 9.1094 × 10⁻³¹ | 1.66 × 10⁻²⁷ |
| 1 × 10⁻¹⁸ | 6.242 × 10⁰ | 1.1126 × 10⁻³⁵ | 9.1095 × 10⁻³¹ | 1.66 × 10⁻²⁷ |
| 1 × 10⁻¹⁷ | 6.242 × 10¹ | 1.1126 × 10⁻³⁴ | 9.1106 × 1⁻³¹ | 1.66 × 10⁻²⁷ |
| 1 × 10⁻¹⁶ | 6.242 × 10² | 1.1126 × 10⁻³³ | 9.1207 × 10⁻³¹ | 1.66 × 10⁻²⁷ |
| 1 × 10⁻¹⁵ | 6.242 × 10³ | 1.1126 × 10⁻³² | 9.2207 × 10⁻³¹ | 1.66 × 10⁻²⁷ |
| 1 × 10⁻¹⁴ | 6.242 × 10⁴ | 1.1126 × 10⁻³¹ | 10.333 × 10⁻³¹ | 1.66 × 10⁻²⁷ |
| 1 × 10⁻¹³ | 6.242 × 10⁵ | 1.1126 × 10⁻³⁰ | 18.238 × 10⁻³¹ | 166 × 10⁻²⁷ |
| 6.66 × 10⁻¹³ | 4.15 × 10⁶ | 7.40 × 10⁻³⁰ | 7.40 × 10⁻³⁰ | 1.67 × 10⁻²⁷ |
| 1 × 10⁻¹² | 6.242 × 10⁶ | 1.1126 × 10⁻²⁹ | 1.2026 × 10⁻²⁹ | 1.68 × 10⁻²⁷ |
| 1 × 10⁻¹¹ | 6.242 × 10⁷ | 1.1126 × 10⁻²⁸ | 1.1216 × 10⁻²⁸ | 1.77 × 10⁻²⁷ |
| 1.492 × 10⁻¹⁰ | 9.31 × 10⁸ | 1.66 × 10⁻²⁸ | 1.68 × 10⁻²⁷ | 3.32 × 10⁻²⁷ |

The zero energy (naked) electron mass is assumed to be approximately the same as published values of mass of the electron at rest, i.e. 9.1094×10⁻³¹ kg. The zero energy (naked) proton mass is determined by assuming that the iron 56 isotope is comprised of 56 protons with no captured entrons and 56 electrons with no captured entrons. (The reader should understand that when I am referring to zero energy/mass, I am referring to zero electrical energy contributed by captured entrons. In this context the zero energy particles (naked particles) have very significant kinetic energy, due to their self-propelled velocity, but no entron energy.) We will learn later on that the energy of entrons captured by electrons or an ion (the naked proton is an ion) is equivalent to electrical energy on an atomic scale. Entron masses, energetic electron masses and energetic proton masses are shown in Table VI for entron energies form 0 joules to 1.492×10⁻¹⁰ joules. This latter entron is the highest energy entron in our Universe, the neutrino entron. Table VII provides energetic electron and proton energies and energetic electron velocities for the same range of entron energies.

TABLE VII
Energetic Electrons and Protons Energy and Velocity

| Entron | | | Energetic | Energetic |
|---|---|---|---|---|
| Energy | Energetic | Energetic | Electron | Proton |
| (J) | Electron Energy | Proton Energy | Velocity | Velocity |
| (kg-m²/s²) | (J) | (J) | (m/s) | (m/s) |
| zero | 2.16 × 10⁻¹⁸ | 1.34 × 10⁻¹² | +2.18 × 10⁶ | +4.0226 × 10⁷ |
| 1 × 10⁻³⁰ | 2.16 × 10⁻¹⁸ | 1.34 × 10⁻¹² | +2.18 × 10⁶ | +4.0226 × 10⁷ |
| 1 × 10⁻²⁷ | 2.16 × 10⁻¹⁸ | 1.34 × 10⁻¹² | +2.18 × 10⁶ | +4.0226 × 10⁷ |
| 1 × 10⁻²⁴ | 2.16 × 10⁻¹⁸ | 1.34 × 10⁻¹² | +2.18 × 10⁶ | +4.0226 × 10⁷ |
| 1 × 10⁻²¹ | 2.16 × 10⁻¹⁸ | 1.34 × 10⁻¹² | +2.18 × 10⁶ | +4.0226 × 10⁷ |
| 1 × 10⁻¹⁹ | 2.06 × 10⁻¹⁸ | 1.34 × 10⁻¹² | +2.13 × 10⁶ | +4.0226 × 10⁷ |
| 1 × 10⁻¹⁸ | 1.06 × 10⁻¹⁸ | 1.34 × 10⁻¹² | +1.523 × 10⁶ | +4.0226 × 10⁷ |
| 2.16 × 10⁻¹⁸ | zero | 1.34 × 10⁻¹² | zero | +4.0226 × 10⁷ |
| 1 × 10⁻¹⁷ | 7.84 × 10⁻¹⁸ | 1.34 × 10⁻¹² | −3.423 × 10⁶ | +4.0226 × 10⁷ |
| 1 × 10⁻¹⁶ | 9.8 × 10⁻¹⁷ | 1.34 × 10⁻¹² | −2.146 × 10⁷ | +4.0226 × 10⁷ |
| 1 × 10⁻¹⁵ | −1 × 10⁻¹⁵ | 1.34 × 10⁻¹² | −4.658 × 10⁷ | +4.0226 × 10⁷ |
| 1 × 10⁻¹³ | −1. × 10⁻¹³ | 1.34 × 10⁻¹² | −4.24 × 10⁸ | +2.730 × 10⁷ |
| 6.66 × 10⁻¹³ | −6.66 × 10⁻¹³ | zero | −4.24 × 10⁸ | zero |
| 1 × 10⁻¹² | −1 × 10⁻¹² | 0.34 × 10⁻¹² | −4.24 × 10⁸ | −2.017 × 10⁷ |
| 1.492 × 10⁻¹⁰ | 1.492 × 10⁻¹⁰ | 1.498 × 10⁻¹⁰ | −4.24 × 10⁸ | −2.98 × 10⁸ |

### Neutron, Deuterium Nuclei, Tritium Nuclei and Helium Nuclei

The neutron is a hydrogen nuclei and a single orbiting high energy electron. The deuterium nuclei is two naked protons and one high energy electron and enough entrons to reduce its natural velocity to approximately zero. The tritium nucleus is three naked protons, two high energy electrons and enough entrons to reduce its natural velocity to approximately zero. The alpha particle is four naked protons, two naked electrons and enough entrons to reduce its natural velocity to approximately zero.

### Nuclear Fusion and Nuclear Fission

The Ross Model assumes that all stable nuclei (except the hydrogen I nuclear and possibly iron-56) are comprised of only naked electrons, naked protons and high-energy entrons. The iron 56 nuclei may not contain any high energy entrons. The helium nucleus is a naked alpha particle plus enough high-energy entrons captured by the naked alpha particle to slow it down so it can capture two electrons to form a helium atom. When hydrogen nuclei and/or helium nuclei are fused in an extremely hot environment (produced by high-energy entrons/photons) to produce heavier atoms, the high-energy entrons which are a part of the fusing atoms are released in the form of high-energy gamma ray photons that create the extremely hot environment to keep the process going. When very massive uranium or plutonium atoms fission, entrons are also released in the form of high-energy gamma ray photons.

### Gravity

According to the Ross Model protons are destroyed only when combined with an anti-proton. All or almost all of this destruction in nature takes place in Black Holes. Each destroyed proton and anti-protons each releases a neutrino photon which is comprised of one neutrino entron having a diameter of 1.46×10⁻¹⁸ meters which is about 100 million times smaller than a typical atom. These neutrino photons spread out from the Black Hole at the speed of light. Most of them pass right through objects such as stars and planets. As they do the Coulomb forces from the entron's two tronnies apply forces to the side and rear of the neutrino photon's path. The neutrino photon produces no force in its forward direction, since it is traveling at the same speed as its Coulomb force. FIG. 4A shows the forces applied to the charges in a typical atom as a newtrino photon passes by. At time zero the neutrino photon passes atom 344 but the atom does not sense the neutrino photon until the neutrino photon has passed it. However atom 344 does feel the Coulomb force waves emitted from neutrino photon continuously after the neutrino photon has passed by. FIG. 4A shows Coulomb force waves 340 emitted at 1 ps, 2 ps, 3 ps and 6 ps. All of these waves are pushing atom 344 back toward the source of the neutrino photon. Force wave 340B was emitted at 3 ps and 340A was emitted at 6 ps. The result is everything in the path of the neutrino photon (which is everything in the galaxy surrounding the Black Hole), feels a force, due to the passing through neutrino photons that pushes everything in the galaxy back toward the Black Hole. Some of the neutrino photons are stopped temporally and later released from objects they encounter, such as stars, planets and moons. These temporally stopped and later released neutrino photons are released in random directions to provide the stars, planets and moons their gravity.

### Neutrino Photons Passage Through Matter

How can neutrino photons carry gravity from Black Holes to the rest of its galaxy and in addition provide the gravity for all of the elements in its galaxy? The secrete is its ability to allow a very small portion of its flux to be captured in suns, planets and moons and later released to provide the gravity of those suns, planets and moons. The following is a simple example indicating a possible explanation.

Our example is the earth which has a diameter of 6.37×10⁶ m and a core of mostly iron. Iron has a density of about 7.8 gm/cm³. One gram atomic weight of iron 56 is about 56 grams. Therefore the volume of one gram atomic weight of iron 56 is about 7.1 cm³. This is a cube with three sides of about 1.9 cm. This cube contains 6.023×10²³ atoms of iron-56. The volume occupied by each atom is about:

V=7.1 cm³/6.023×10²³ atoms/cm³=11.8×10⁻²⁴ cm³.

This is iron atom is modeled as a tiny cube with three sides of about 2.3×10⁻⁸ cm. The iron atom is comprised of 26 orbiting electrons and a nucleus with a diameter of about 1×10⁻¹² cm; so we can model it as a cube with sides of 1×10⁻¹² cm (1×10⁻¹⁴ m). We can model the orbiting electrons as cubes with sides of about 1×10⁻¹⁸ m a (1×10⁻¹⁶ cm). The nucleus according to the Ross Model is comprised of 14 alpha particles and two electrons or since alpha particles are each comprised of four protons and two electrons, the nucleus is comprised of 56 protons and 30 electrons. But each proton is comprised of two positrons and one electron so the nucleus of the iron 56 atom contains 112 positrons and 86 electrons. (Remember the each proton gets almost all of its mass from a captured neutrino entron, but the entron is not important with respect to the passage of neutrino photons through matter. Entrons cannot capture other entrons.) If we add the 26 orbiting electrons, we see that the iron 56 atom is comprised of 112 positrons and 112 electrons. Electrons and positrons each have a diameter of about 1×10⁻¹⁸ m or about 1×10⁻¹⁶ cm; so we could estimate the cross section o of an electron or positron as 1×10⁻³² cm². There are 224 electrons and positrons in the atom; so the total cross section Nσ of an iron 56 atom would be about (224)(1×10⁻³² cm²)=224×10⁻³² cm² or 2.24×10⁻³¹ cm²/atom.

There are 6.023×10²³ atoms per 7.1 cm³ of iron 56 which is equivalent to 8.5×10²² atoms/cm³. Therefore, cross section of the components of iron 56 atoms by this simplified analysis would be (8.5×10²² atoms/cm³)(2.24×10⁻³⁰ cm²/atom)=1.9×10⁻⁷ cm²/cm³. Since the cross section area of this 1 cm³ chunk of iron-56 is 1 cm², we could estimate the probability of an electron in this 1 cm³ chunk capturing a neutrino photon as the ratio of 1.9×10⁻⁷ to 1.0. This would provide a probability of capture at 1.9×10⁻⁷ (0.00000019) and the probability of no capture at 0.99999981.

So let's see with these assumptions if a neutmo has a good chance of passing through our earth. If we know the probability of a neutrino not being captured when passing through 1.0 cm of iron, we can calculate the probability of passing through 2.0 cm of iron by multiplying the probability by itself. The probability of the neutrino photon passing through 10 cm of iron would be (0.99999981)10 which is 0.999999. The probability of the photon passing through 100 cm (1.0 m) of iron would similarly be 0.99999. (Interestingly, we lose a 9 each time we increase the distance by a factor of 10. At 1 kilometer the neutrino photon has only probability of making it through of only about 99 percent (0.99) and only a 0.03 percent chance of making it through 800,000 meters and virtually no chance at all of making it all the way through the 6.37 million meter diameter earth. This analysis (with these assumptions) shows that the neutrino could travel a great distance through solid iron but not through the entire earth.

According to the Ross Model most neutrino photons illuminating the earth do pass all the way through the earth. And according to the model most neutrino photons illuminating the sun pass through the sun. Therefore, the above estimate of electron cross section must be much too high. We can greatly reduce our estimate of the capture cross section by assuming that for capture of the neutrino entron of a neutrino photon the entron must be traveling at a specific velocity or within a specific velocity range (such as about zero, c or about the same velocity of the capturing electron or positron) when it encounters the electron or positron. Remember that during each cycle of the photon, the entron's speed varies from −1 c to plus 3 c. Also, for capture the entron may need to be closely aligned with the electron. Therefore, I use these concepts to reduce my estimate of the electron's and positron's cross section to a low enough value that the probability of a single neutrino photon passage through the sun is almost (but not quite a certainty). I therefore decrease my estimate of the cross section of an electron for neutrino photon capture from 1.9×10⁻⁷ cm²/cm³ to about 1×10⁻¹⁴ cm²/cm³.

### Two Tronnies can not Annihilate Each Other

According to the Ross Model it is impossible for tronnies to annihilate each other. Two unlike tronnies do attract each other but they repel themselves with a force that is always greater than the attractive force of other tronnies. They do, as explained above, combine in dynamic, equilibrium combinations to form entrons, photons, electrons and everything else in our Universe. The closer together they are in these dynamic equilibrium combinations, the greater their energy and mass. According to the Ross Model, all of the tronnies that have ever existed still exist. And it is impossible to destroy a tronnie.

### Energetic Electrons Can Shed Their Entrons

An entron captured by an electron can escape in the form of a photon. We will learn later that the electron can release its entron in the form of heat energy that can increase the temperature of the heating elements of your toaster until the elements are red hot. Entrons in the red hot elements can then escape in the form of visible light photons that we see and that may be absorbed in the toast increasing its temperature and changing its chemical structure until the toast is golden brown.

### How to Make Electrons and Positrons

### Pair Production

We know by virtue of many experiments that high-energy photons can produce a pair of electrons (one positron and one electron) in a process called pair production. Most scientists currently believe that only a single gamma ray photon (having energy equal to 1.02 MeV which is equivalent in mass to about 18.2×10⁻³¹ kg) is needed for pair production. This may seem logical since this mass is equal to the combined mass of one electron and one positron, each of which has a mass of about 9.1×10⁻³ kg. Most scientists currently believe that photons have no charge and they are not concerned that something with zero charge can produce two things with opposite charges. They explain that the sum of the charge of the electron plus the charge of the positron gives a net zero charge which is equal to the net charge of the single photon.

The Ross Model provides a much better explanation of pair production. As described above, one entron is made of two tronnies, one plus tronnie and one minus tronnie. Therefore, three entrons would all together provide a total of three plus tronnies and three minus tronnies). As described above the diameter of a 1.02 MeV entron is 3.349×10⁻¹⁵ m and the capture of a very low energy entron with mass and energy smaller than one millionth of the mass of the 1.02 MeV entron) causes the velocity of the electron to be reduced. As described above the tronnies of a low-energy entron and a high-energy entron captured by a single electron can change partners to produce two identical twin entrons each with energies equal to half the sum of the high and low energy entrons. We also briefly discussed the extremely high-energy 931 MeV neutrino entron which has a diameter of 1.46×10⁻¹⁸, about 1000 times smaller than a proton. These three entrons are what is needed to make a pair of electrons. How about the availability of these three entrons? Entrons in the low eV range are extremely plentiful everywhere in our Universe. Also neutrino photons are the carriers of the force of gravity so that in all matter that feels the force of gravity, neutrino photons (and the neutrino entrons that are the energy portions of these photons) must also be extremely plentiful everywhere in our Universe. All we need are some 1.02 MeV gamma ray photons to provide the 1.02 MeV entrons.

### Modeling Pair Production

A proposed process for pair production can be described as follows. A naked electron has captured a low energy entron. It also captures high energy 1.02 MeV entron (with a diameter of about 1.345×10⁻¹⁵) from a gamma ray photon. The combined energy of these two entrons is still very close to 1.02 MeV. The two entrons change partners to produce two twin 0.51 MeV entrons (each with a diameter of about 0.67×10⁻¹⁵ m). Next a 931 MeV neutrino entron (with a diameter of about 1.46×10⁻¹⁸ m) is captured by the electron. The neutrino entron's diameter is the same as the diameter of the circling plus tronnie in the center of the electron and the entron's frequency is the same as the frequency of the electron (i.e. 1.16×10²⁵ cycles per second). The forces of these three entrons boosts the speed of the electron to a speed exceeding the speed of light which causes the electron to shed all of its entrons. While the electron is accelerating the two 0.51 MeV entrons begin to spin rapidly ultimately reaching the natural frequency of the neutrino entron, about 1.16×10²⁵ cycles per second, and correspondingly reducing their diameters by an equivalent factor of 465 to the same diameter as that of the plus tronnie in the electron and the neutrino entron. The electron breaks away leaving the two shrunken 0.51 MeV entrons circling the path of the 931 MeV entron. The plus tronnies of the two 0.51 MeV entrons decide they prefer to be with the minus tronnie of the 931 MeV neutrino entron and the minus tronnies of the two 0.51 MeV entrons decide they prefer to be with the plus tronnie of the 931 MeV neutrino entron. This is an unstable configuration and it quickly divides into a positron and an electron. Both the electron and the positron have the same basic shape (see FIG. 4A) but their net charge and the charges of their tronnies are opposite as I have previously explained.

This is, according to this current (ninth) version of the Ross Model, how to create electrons and positrons. Note we did it with an electron and three entrons. We ended up with the original electron and a new electron with three tronnies (one plus tronnie and two minus tronnies) and a new positron (with one minus tronnie and two plus tronnies), so we have conservation of charge. What about mass? The electron that captured the entrons is on both sides of the equation so we can ignore it; i.e. it existed before the event and was not destroyed by it. The very low energy entron has a mass that is negligible so we can ignore it. The masses of the electron and the positron equal the mass/energy of the 1.02 MeV entron. But what about the neutrino entron? Here is 931 MeV and its equivalent mass has vanished in the process of creating the electron-positron pair. One of its tronnies (the minus tronnie) went with the positron and the other one (the plus tronnie) went with the electron. The question is do we have a violation of conservation of mass/energy? It would appear that we do, but let's not get too excited about this apparent violation of mass and energy conservation until we consider the next section.

### Positron-Electron Annihilation

As I explained in the Background section, it is well known that positrons are strongly attracted to the negative electron (they have opposite charges and opposite charges attract) and that when a low-energy electron and a low-energy positron collide they annihilate each other producing two 0.51 MeV photons that escape in opposite directions. The combined energy of the two photons is equivalent to the combined masses of the negatron and the positron (i.e. 0.51 MeV+0.51 MeV=1.02 MeV). This process has been used as proof of Einstein's famous equation: E=mc². This is not how it works according to the Ross Model.

According to the Ross Model, when the electron and the positron combine, the two central tronnies each of which are circling with a diameter of 1.46×10⁻¹⁸ m combine to form a new 931 MeV neutrino entron (with a diameter of 1.46×10⁻¹⁸ m) that quickly speeds away as a neutrino photon undetected at the speed of light. The other four tronnies (the two minus tronnies from the electron and the two plus tronnies from the positron) continue to spin but without the central tronnies holding them in tight orbits, they change partners (making two plus and minus pairs), widen their orbits and slow down their spins until their orbits reach diameters of 2.42×10⁻¹⁴ m then they break into two 0.51 MeV entrons that speed away in opposite directions as 0.51 MeV photons. So here we end up with three entrons two at 0.51 MeV each and one at 931 MeV (or three photons) with 3 plus and 3 minus tronnies which is the same as we had in the electron and positron so we have conservation of charge. The energy of the two 0.51 MeV photons equal the combined mass of the electron and the positron. But we have gained mass/energy equal to the mass/energy of the 931 MeV neutrino photon! So we do not have conservation of mass/energy in this example either. However, if we consider an example of pair production in concert with a subsequent electron-positron annihilation then we do have conservation of not only charge but mass/energy also!

Typical entrons can lose or gain energy as they mingle with other entrons, especially in the presence of matter; however, according to the Ross Model, neutrino entrons and neutrino photons never lose or gain energy. They do disappear and re appear in the course of pair production and electron-positron annihilation. Neutrino entrons can become neutrino photons and vice versa. Neutrino photons are so much more energetic than all other entrons or photons that they just don't mingle very well. They are in a class by themselves. In an evolving universe, they spend nearly all of their lives either as almost all the mass of a proton or as a neutrino photon providing gravity for a galaxy. During the periods following big bangs they participated, big time, in the process of proton formation. (As I will suggest later on, they may still be participating in proton formation in the outer shell of our Universe.)

### An Equal Number of Positrons and Electrons in Our Universe

According to the Ross Model, it is impossible to form a positron without, at the same time, forming an electron, and vice versa. If all naked electrons are the same and all naked positrons are the same and if electrons are the same as positrons except for their plus and minus tronnies being opposite (all of which, according to the Ross Model, is true), there must be a very stable equilibrium electron structure. It is according to the Ross Model the structure you see in FIG. 5. According to the Ross Model can only be produced together at the same time in the pair production process and this dynamic spiraling structure cannot be destroyed except in electron positron annihilation. Therefore, there must be an equal number of electron and positrons in our Universe. Current theories and all experimental evidence based on those current theories account for only a very, very few positrons compared to the enormous number of electrons that we know populate our Universe. What the current theories do not appreciate is that every proton has within it two positrons! The result is that every neutral atom then has exactly the same number of positrons as electrons. Current theories do support the general notion that there is a lot of symmetry in our Universe. They just do not appreciate how much symmetry there really is. The Ross Model does.

### A Positron Model

The positron model is exactly the same as a electron model shown in FIG. 4 except the signs of the three tronnies are reversed. In the negatron the central circling tronnie is a minus tronnie and the two tronnies orbiting the circular path are plus tronnies. The natural speed of the naked positron should be exactly the same as the natural speed of the naked negatron.

### How to Make Atoms and Everything Else from Electrons, Protons and Entrons

### Electron, Protons and Entrons

Now we get to the fun part. We have already learned that entrons, electrons and protons are made from nothing but plus and minus tronnies and that protons are made from one electron, two positrons and one neutrino entron. Now we will discover how God made everything else in our Universe from electrons, protons and entrons. We learned that an entron is nothing but two oppositely charged circling tronnies. We learned that naked electrons are nothing but three tronnies. These were two plus and one minus for positive electrons (positrons) or two minus and one plus for negative electrons circling together in their special triple tronnie twirl at 1.16×10²⁵ cycles per second. And we learned that energetic electrons are electrons that have captured at least one entron. Then we learned that naked protons are nothing but two positrons and one very high energy electron. The very high energy electron has captured a neutrino entron, causing the electron to circle in a very small circle at a velocity in excess of the speed of light with its massive entron giving it a mass that is about 1800 times the mass of the naked electron. We learned when you add up all the tronnies in the naked proton we get 11 (nine in the naked electron and the two positrons and two in the neutrino entron). And last we learned that an energetic proton (the hydrogen nucleus) was a naked proton that had captured additional entrons.

So we know that entrons, electrons and protons are made from tronnies, the basic building blocks of our Universe. These entrons, electrons and protons are what I refer to as composite building blocks because they are comprised of the basic building blocks (tronnies) and they will be used to construct everything else in our Universe.

So entrons are made from tronnies. Two electrons are made from three entrons. A protons is made from two positive and one negative electron and one very high energy entron. What I am trying to show in this section is that everything else in our Universe is made from entrons, electrons and protons, everything else includes us, our earth, our sun, our galaxy and all other galaxies and the light we see and the radio waves that carry digital information to our cellular telephones. The numbers of tronnies in these composite building blocks are summed up in Table IX below:

TABLE IX
Tronnies in Entrons, Electrons and Protons

| Composite Building Block | Number of Tronnies |
|---|---|
| Entron | 2 |
| Naked Electron | 3 |
| Energetic Electron | 5 |
| Naked Proton | 11 |
| Energetic Proton | 13 or more |

Ok, let's start building models of things. We will start with photons. Then we will look at the hydrogen nucleus and the neutron. Then we will start putting together the nuclei of isotopes of all of the light atoms and some of the heavy atoms. After that we will have a short discussion about orbital electrons. After we have explained the structure of atoms, we will have a few words about molecules and chemistry until you have the basic strategy of building our Universe from the basic building blocks all according to the Ross Model.

### Photons

We have already learned that a photon is one self-propelled entron. The photon is graphically described in FIGS. 3 and 4.

### Atomic Numbers and Masses

Neutrons and all atoms are made from combinations of naked protons, naked electrons and entrons. Molecules are made from combinations of atoms and entrons. Everything else in our Universe is made from combinations of atoms, molecules and entrons.

The question for now is how are these neutrons, atoms and molecules assembled from the naked protons, naked electrons and entrons. To help figure this out, first we will consider the atomic number and masses of neutrons and atoms. Most atoms have several naturally occurring isotopes. The atomic number of all isotopes of all atoms is equal to the number of electrons surrounding the nucleus of the charge neutral isotope. For example all charge neutral oxygen isotopes have eight orbiting electrons, so all isotopes of oxygen have an atomic number of eight. The mass number of an isotope is the closest whole number to the mass of the isotope measured in atomic mass units (amu's). According to accepted atomic theory the mass of any isotope is approximately equal to the mass of all of the protons and neutrons in the nucleus of the isotope plus some additional mass associated with what is believed to be something called “binding energy”. Existing theories also explain that this binding energy in the nucleus helps bind the nucleus together. In addition the relatively very light orbiting electrons make a small contribution to the mass of the atoms. According to the Ross Model, the current thinking on the structure of atoms is very misguided.

According to the Ross Model there are no neutrons in stable atomic nuclei. There are only naked electrons, naked protons and high-energy entrons. We have estimated the mass of the naked protons, we know the mass of the naked electron and we have estimated the natural speed of naked electrons and naked protons. The actual mass of all isotopes of all atoms are known with great accuracy from careful experiments. Some of these mass values are provided in Table X. The mass units are atomic mass units. We also know that atoms have spin and we know the spin is not the same in all atoms. So we can now utilize all of this information to predict how each of the atoms are constructed. In this specification I will not try to describe all isotopes of all atoms. There are 92 distinct naturally occurring types of atoms, each type having its own atomic number and chemical properties, that have at least one stable isotope. Most of these 92 atoms have more than one stable isotope and many unstable isotopes. So there are several hundred isotopes. I have picked only a few isotopes for examples and will try to describe their structure. I will concentrate on isotopes of the lightest atoms first.

First let us consider the masses and spin of the neutron (which is not stable but has a half life of only 15 minutes) and the most stable isotope of atoms with atomic numbers 1 through 20. This information is extracted from the 77^{th} (1996-1997) Edition of the CRC Handbook of Chemistry and Physics, published by CRC Press. This information is summarized in Table X.

In Table XI, I have listed the calculated mass difference between the measured masses of each of the isotopes listed in Table XI and the sum of the masses of the naked protons and electrons making up each isotope according to the Ross Model. This difference according to the Ross Model is equal to the mass of the entron or entrons in the isotope. You should notice that this mass difference for the iron-56 isotope is zero. This results from the fact that I used this isotope to estimate the mass of the naked proton under the assumption that there were no entrons with significant mass in the iron-56 isotope.

The size of nuclei is generally believed to be approximated by the following formula:

r=r₀A^{1/3}

where r is the radius, r₀=1.2×10⁻¹⁵ m and A is the mass number of the isotope. So, for example, iron-56 with a mass number of 56 would have a radius of about 5.5×10⁻¹⁵ m, since the cube root of 56 is about 4.59. The largest stable isotope is uranium-238. Its nucleus has a diameter of about 6.2×10⁻¹⁵ m. Helium with a mass number of 4 would have a radius of about 1.92×10⁻¹⁵. Oxygen with a mass number of 16 would have a radius of about 3×10⁻¹⁵ m.

TABLE X
Alpha Particle Combinations to Form Atomic Nuclei

| | Atomic | Mass | Number of | Percent |
|---|---|---|---|---|
| Atom | Number | Number | Alpha Particles | Abundance |
| Helium | 2 | 4 | 1 | 100 |

A combination of two alpha particles is not stable

| | | | | |
|---|---|---|---|---|
| Carbon | 6 | 12 | 3 | 98.9 |
| Oxygen | 8 | 16 | 4 | 99.8 |
| Neon | 10 | 20 | 5 | 90.5 |
| Magnesium | 12 | 24 | 6 | 79.0 |
| Silicon | 14 | 28 | 7 | 92.2 |
| Sulfur | 16 | 32 | 8 | 95.0 |
| Argon | 18 | 40 | 10 | 99.6 |
| Calcium | 20 | 40 | 10 | 96.9 |
| Calcium | 20 | 44 | 11 | 2.1 |
| Titanium | 22 | 48 | 12 | 73.7 |
| Chromium | 24 | 52 | 13 | 83.8 |
| Iron | 26 | 56 | 14 | 91.8 |
| Nickel | 28 | 60 | 15 | 26.2 |
| Zinc | 30 | 64 | 16 | 48.6 |
| Zinc | 30 | 68 | 17 | 18.4 |
| Germanium | 32 | 72 | 18 | 27.7 |
| Germanium | 32 | 76 | 19 | 7.44 |
| Selenium | 34 | 80 | 20 | 46.6 |
| Krypton | 36 | 80 | 20 | 2.25 |
| Krypton | 36 | 84 | 21 | 57.0 |
| Strontium | 38 | 84 | 21 | 0.56 |
| Strontium | 38 | 88 | 22 | 82.6 |

TABLE XI
Atomic Masses and Spin

| | A- | | | | |
|---|---|---|---|---|---|
| | tom- | | | | |
| | ic | | | | |
| | Num- | Atomic | Abundance | Atomic Mass | |
| Atom | ber | Isotope | (percent) | (amu) | Spin |
| Neutron | 0 | ₀n | | 1.00866492 | ½+ |
| Hydrogen | 1 | ¹H | 99.985 | 1.00782 | ½+ |
| Deuterium | 1 | ²H | 0.015 | 2.014101778 | 1+ |
| Tritium | 1 | 3H | 0 (12.32 y) | 3.01602931 | ½+ |
| Helium | 2 | ²He | 100 | 4.00260325 | 0+ |
| Lithium | 3 | ⁷Li | 92.5 | 7.0116004 | 3/2− |
| Beryllium | 4 | ⁹Be | 100 | 9.0121821 | 3/2− |
| Boron | 5 | ¹¹B | 80.1 | 11.009306 | 3/2− |
| Carbon | 5 | ¹²C | 98.89 | 12.000000 | 0 |
| Nitrogen | 6 | ¹⁴N | 99.634 | 14.00307401 | 1+ |
| Oxygen | 8 | ¹⁶O | 99.762 | 15.99491462 | 0 |
| Fluorine | 9 | ¹⁹F | 100 | 18.9984032 | ½+ |
| Neon | 10 | ²⁰Ne | 90.48 | 10.99244018 | 0 |
| Sodium | 11 | ²³Na | 100 | 229897697 | 3/2+ |
| Mag- | 12 | ²⁴Mg | 78.99 | 23.9850419 | 0 |
| nesium | | | | | |
| Aluminum | 13 | ²⁷Al | 100 | 26.9815384 | 5/2+ |
| Silicon | 14 | ²⁸Si | 92.23 | 27.9769265 | 0 |
| Phos- | 15 | ³¹P | 100 | 30.9737615 | ½+ |
| phorus | | | | | |
| Iron | 56 | ⁵⁶Fe | 91.75 | 55.934942 | 0 |
| Gold | 197 | ¹⁹⁷Au | 100 | 196.966552 | 3/2+ |
| Lead | 208 | ²⁰⁸Pb | 52.4 | 207.976636 | 0 |
| Uranium | 235 | ²³⁵U | 0.72 | 235.043923 | 7/2− |
| Uranium | 238 | ²³⁸U | 99.274 | 238.050783 | 0 |

TABLE XII
Nuclear Masses

| | | | | Mass | | |
|---|---|---|---|---|---|---|
| | | | | of Naked | Total | |
| | | | | Protons & | Enton | Entron |
| | Atomic | Atomic | Atomic Mass | Electrons | Mass | Energy |
| Atom | Number | Isotope | (amu) | (amu) | (amu) | (MeV) |
| Electron | | | 0.000548 | | | |
| Neutron | 0 | ₀n | 1.00866492 | 0.99883825 | 0.00982667 | 9.1585 |
| Hydrogen | 1 | ¹H | 1.00782 | 0.99883825 | 0.00898175 | 8.3701 |
| Deuterium | 1 | ²H | 2.014101778 | 1.9976765 | 0.016425278 | 15.3084 |
| Tritium | 1 | 3H | 3.01602931 | 2.99651475 | 0.01951456 | 18.1876 |
| Helium | 2 | ⁴He | 4.00260325 | 3.9953530 | 0.00725025 | 6.7572 |
| Lithium | 3 | ⁷Li | 7.0116004 | 6.99186775 | 0.01973265 | 18.3514 |
| Beryllium | 4 | ⁹Be | 9.0121821 | 8.98954425 | 0.02263785 | 21.0985 |
| Boron | 5 | ¹¹B | 11.009306 | 10.98722075 | 0.02208525 | 20.5529 |
| Carbon | 6 | ¹²C | 12.000000 | 11.986069 | 0.013931 | 12.9837 |
| Nitrogen | 7 | ¹⁴N | 14.00307401 | 13.9837355 | 0.01933851 | 18.0235 |
| Oxygen | 8 | ¹⁶O | 15.99491462 | 15.981412 | 0.01350262 | 12.5844 |
| Fluorine | 9 | ¹⁹F | 18.9984032 | 18.97792675 | 0.02047645 | 19.0840 |
| Neon | 10 | ²⁰Ne | 19.9924402 | 19.976765 | 0.0156842 | 14.6177 |
| Sodium | 11 | ²³Na | 22.9897697 | 22.97327975 | 0.01648995 | 15.3686 |
| Magnesium | 12 | ²⁴Mg | 23.9850419 | 23.972118 | 0.0129239 | 12.0281 |
| Aluminum | 13 | ²⁷Al | 26.9815384 | 26.96863275 | 0.01290565 | 12.0289 |
| Silicon | 14 | ²⁸Si | 27.9769265 | 27.967471 | 0.0094555 | 8.8125 |
| Phosphorus | 15 | ³¹P | 30.9737615 | 30.96398575 | 0.00977575 | 9.1110 |
| Iron | 56 | ⁵⁶Fe | 55.934942 | 55.934942 | 0.000000 | 0 |
| Gold | 197 | ¹⁹⁷Au | 196.966552 | 96.7711353 | 0.1954167 | 182.13 |
| Lead | 208 | ²⁰⁸Pb | 207.976636 | 207.758356 | 0.21828 | 203.44 |
| Uranium | 235 | ²³⁵U | 235.043923 | 234.7269888 | 0.3169342 | 295.38 |
| Uranium | 238 | ²³⁸U | 238.050783 | 237.7235035 | 0.3272795 | 305.02 |

### The Nucleus of the Hydrogen Atom

According to existing theories the nucleus of the most abundant isotope of hydrogen, H¹, is merely a proton. The Ross Model differs slightly. According to the Ross Model the proton (at least the naked proton) is traveling too fast (i.e. 2.828×10⁷ m/s, almost 0.1 the speed of light) to capture an orbital electron. In order to capture an orbital electron to become a hydrogen atom, the proton must slow down to a speed much closer to zero. The proton captures a sufficient number of entrons so that its entron energy equals about 8.37 MeV which slows the naked electron down to approximately zero velocity. FIG. 8 is a proposed graphical model of the hydrogen-1 nucleus. It is exactly like the model of the naked proton shown in FIG. 7 except it has six entrons with energies totaling 8.37 MeV circling through it to slow it down to close to zero speed. The diameter of the 8.37 MeV entron would be about 0.162×10⁻¹⁵ m, which is significantly smaller than the size of the naked proton so it could not serve as a brake to slow down the proton. However each of the six 1.395 MeV entrons with diameters of 9.754×10⁻¹⁶ m might combine to provide sufficient breaking force on the proton. Also twelve 0.6975 MeV entrons with diameters of 1.951×10⁻¹⁵ m. should also work.

### Neutrons

According to the Standard Model, the nuclei of all atoms except the most abundant hydrogen atom contains a number of neutrons that are about equal to, or somewhat more than, the number of protons in the nuclei. Two or three neutrons are released when an atom of uranium fissions during fission processes such as in an uncontrolled chain reaction (like an atomic bomb explosion) or in a controlled chain reaction (like inside a nuclear reactor). The chain reaction that keeps the reactor producing power depends on the control of the population of these neutrons. Neutrons are supposed to be very stable when inside most nuclei. Scientists know that neutrons are very unstable when outside atomic nuclei. They decay after a short lifetime, averaging about 15 minutes, into a proton and an electron and something else. Scientists think that something else is an old fashion neutrino.

According to the Standard Model a neutron is suppose to be made of quarks. A quark is supposed to have charges equal to a fraction of an electron charge. No one has ever detected a quark and no one has ever detected a charge smaller than the electron charge. Still scientists believe in quarks. As explained above, scientists have known for many years that the decay products of neutron decay are a proton and an electron. To me, it is almost beyond belief that the scientific community has not suspected that the neutron must be made of an electron and a proton.

The Ross Model proposes two models of neutrons. According to the first model the neutron is made of a naked proton and a naked electron (with a combined mass of 0.99883825 amu) and a number of entrons sufficient to provide the neutron with its mass of 1.00866492 amu. That difference is equivalent to 0.00982667 amu and 9.1585 MeV (see Table XII). For the second model, it may be that neutrons are comprised of a hydrogen-1 nuclei and a naked electron (with a combined mass of 1.00830 amu) and one high energy entron driving the electron is a tight circle corresponding to the high energy entron's diameter. That entron would have a mass 0.00036 amu, 0.3355 MeV). This 0.3355 MeV entron would have a diameter of about 4.057×10⁻¹⁵ m (which is a little larger than the hydrogen nucleus).

According to the Ross Model the neutron does not exist as a separate entity inside the nuclei, at least not for long. The Ross Model proposes that its lifetime inside a nucleus is the same as on the outside (15 minutes on the average). Its parts (the electron, the naked proton and the high-energy entrons) exist inside the nuclei as separate components of the nuclei. Occasionally these parts will be ejected from the nuclei as this unstable, short-lived package which scientists call a neutron. Neutrons ejected from nuclei are ejected with very high kinetic energy. In the fission process (in atomic bombs and nuclear reactors the velocities of these neutrons are about 2.8×10⁷ M/s (about 9 percent of the speed of light). They rightly are called “fast neutrons”. According to the Ross Model the estimated velocity of the naked proton is 4.0226×10⁷. According to the Ross Model naked neutrons like naked electrons and naked protons are self-propelled and like the naked electrons and protons, slow down by capturing high energy entrons. In most nuclear reactors, water is provided to help slow down the neutrons.

Scientists believe the neutron loses its kinetic energy by elastic collisions (similarly to billiard ball collisions) with the hydrogen nuclei in the water. According to the Ross Model the neutron does not lose its velocity by collisions it loses its natural self-propelled velocity by stealing entrons from hydrogen atoms and other atoms in its environment, and these stolen entrons once captured by the neutron reduce the natural speed of the neutron.

Often a neutron will be absorbed in the nuclei of another atom before it decays in which case the components of the neutron becomes a part of the absorbing nuclei. In many cases the nuclei absorbing the neutron will be radioactive as a result of the absorption and as a result will release an electron, a proton or an entron (in the form of a gamma ray photon) to return to a stable condition. This is further support for the Ross Model contention that a neutron is merely a combination of a proton, and electron and one or more entrons.

If the neutron is not absorbed quickly it will decay with an average lifetime of about 15 minutes. When the neutron decays after this brief lifetime, the decay products are the proton, the electron and that something else that I referred to above. According to the Ross Model, that something else is the high-energy entron that is released as a gamma ray photon. A big problem is there is not to the best of my knowledge any report of this gamma ray photon. So a good question is why not. It may be that the neutron exiting a uranium nucleus is nothing but a naked proton a naked electron and a single entron. If so that entron would have a mass of 0.00983 amu and an energy of about 9.16 MeV or about 1.467×10⁻¹² J. The answer may be that the energy of the photon is so high that it escapes detection. My estimate of the energy of the high-energy entron and its corresponding gamma ray photon is about 9.16 MeV. My estimate is based on the difference in mass between the neutron mass and the sum of the masses of the naked electron and the naked proton. The 9.16 MeV entron has a diameter according to Table V of approximately 1.485×10⁻¹⁶ m (which is slightly smaller than the naked proton and much larger than the naked electron) so it could exist inside atomic nuclei, which are believed to vary in size from about 1.2×10⁻¹⁵ m to about 6.2×10⁻¹⁵ m. A 9.16 MeV gamma ray would be hard to detect.

### Deuterium Nucleus

Current physics and chemistry books explain that the deuterium nucleus is comprised of a proton and a neutron plus some binding energy. The deuterium nucleus (an energetic deuteron) according to the Ross Model is simply two naked protons plus a naked electron and a number of entrons having a total mass/energy equivalent to 15.29 MeV. A 15.29 MeV entron has a diameter of about 0.890×10⁻¹⁶ m. Therefore several lower energy entrons (with larger diameters) are probably utilized to slow down the deuterium nucleus. A proposed drawing of the naked deuteron is shown in FIG. 9. The entrons are not shown.

### Tritium Nucleus

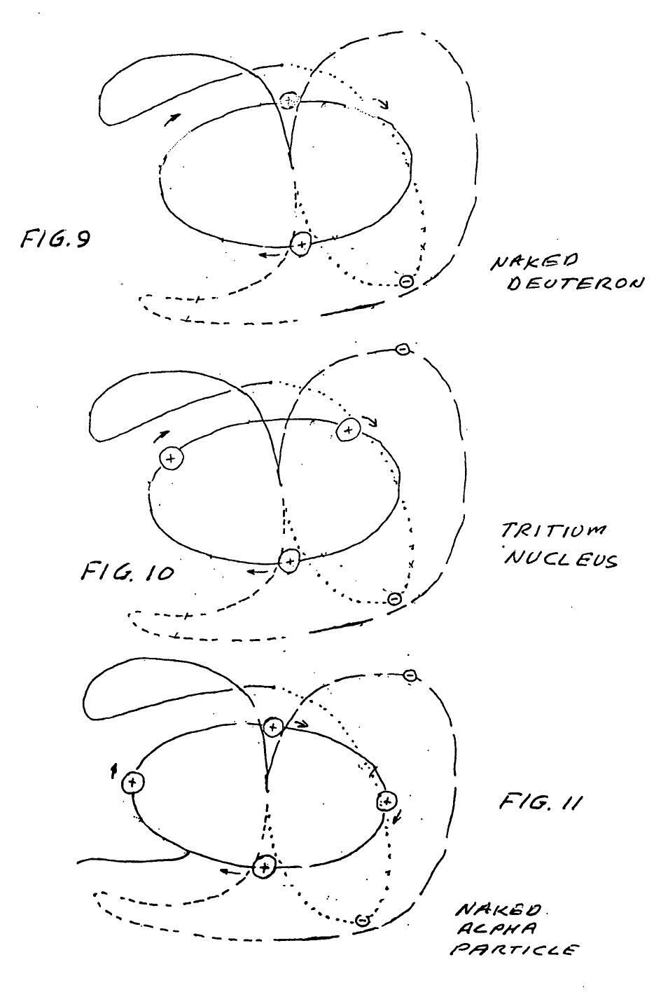

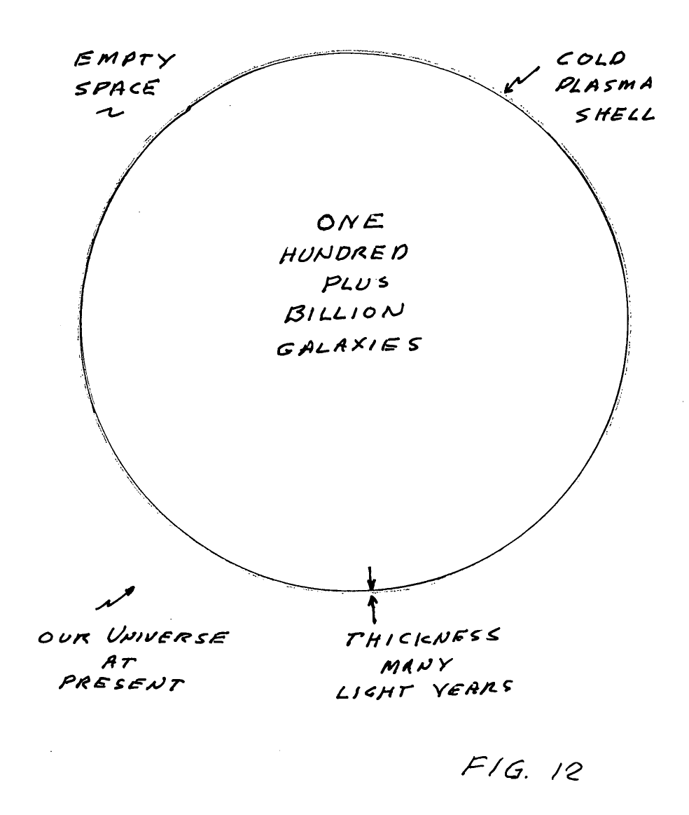

Current physics and chemistry books explain that the tritium nucleus is comprised of a proton and two neutrons plus some binding energy. The tritium nucleus according to the Ross Model is simply three naked protons plus two naked electrons and enough entrons to provide an energy/mass of about 18.187 MeV. Several entrons are probably required to provide the breaking action. A proposed drawing of the triton is shown in FIG. 10. The entrons are not shown. In this structure, the three naked protons circle in a circle with a diameter of 1.4989×10⁻¹⁶ m. The entron with the same radius of 1.4989×10⁻¹⁶ m circles through the center of the proton circle and through the center of both electrons which are moving substantially faster than the speed of light on the same path as the entron through the center of the circling protons.

### The Alpha Particle (Helium Nucleus)

Current physics and chemistry books explain that the alpha particle (which is thought to be the same as the helium nucleus) is comprised of two protons and two neutrons plus some binding energy. The alpha particle according to the Ross Model is simply four naked hydrogen atoms plus two naked electrons and a number of entrons having a total mass/energy equivalent to about 6.75 MeV. A proposed drawing of the alpha particle is shown in FIG. 11. Again, the entrons are not shown.

### Building of Atoms

According to the Ross Model, the nuclei of most of the isotopes of most atoms are comprised mostly of alpha particles. Atoms are made in stars. There are lots of alpha particles in stars because stars are mostly made of hydrogen and helium. However, at the temperature of the internal structure of stars the hydrogen and helium atoms are ionized which means that we are talking about the nuclei of helium and hydrogen and separate electrons. According to the Ross Model these are the composite building blocks of the nuclei of atoms along with entrons which are also in great abundance in stars.

In Table XI have listed 23 isotopes with nuclei comprised of nothing but alpha particles and entrons. In Table XI, I have listed the most abundant isotopes of typical atoms with nuclei many of which can not be only combinations of alpha particles and entrons. These nuclei can be constructed with alpha particles and entrons plus an appropriate number of electrons and/or protons. In each case in making these models, care must be exercised to assure that masses and charges of the models correspond to experimental data.

### Electricity and Magnetisms

In our modern societies almost everything we do involves electricity and magnetism. All of our electronic gadgets and all of our motors depend on the forces of electricity and magnetism. Strange as it may seem, existing theories do not provide a clear picture of either electricity or magnetism. If you do not believe it, GOOGLE either term. You will find the no one knows what an electron looks like or what it is made of. You will also discover we know how to create magnetic fields, but no one knows what a magnetic field is. You may also discover that no one has a good explanation of voltage. We all know that most of our home appliances operate at 120 volts AC or 240 volts AC and that our cameras, radios and cell phones operate from DC batteries at lower DC voltages. But what the heck is voltage anyway? The explanations that you will see talk about electric charge and the Coulomb force associated with the charge. But voltage represents energy, so what has charge got to do with energy. Don't get me wrong, scientist and engineers have learned how to deal with electricity and magnetism even though they do not understand it. They have developed mathematical formulas that make accurate predictions and these formulas work very well. We use them to design huge hydroelectric generators and microscopic integrated circuits. But the prior art science still do not know what an electron looks like and it certainly does not know what a magnetic field looks like.

### Voltage, Entrons and Photons

Electrons, positrons and protons have been described above based on the Ross Model. According to the Ross Model, the voltage on a high-voltage electrical conductor is determined by the energy (in volts) of entrons captured by all of the conduction electrons in the conductor. For example, in a conductor connected to the hot (the one not grounded) terminal of a grounded 12-volt battery, all of the conduction electrons have captured an entron with an energy of about 12 eV and a diameter of about 1.0×10⁻¹¹ m. Any electrons at the ground terminal of the battery would have an energy corresponding to the temperature of the terminal. At normal temperatures such as about 300 K (23 C), the energy would be about 1.4×10⁻⁵ eV and the entron diameter would be about 9.6×10⁻⁶ m.

The high voltage terminal of a 2.3 volt battery would provide entrons with a diameter of about 5.9×10⁻¹⁰ m and these entrons in photon form would be visible green light with wavelengths of 5.4×10⁻⁷ m. Entrons in these low voltage ranges are about 10 million times larger than electrons that have captured them. When electrons flow through a resistor they tend to lose their entrons in the resistor. These lost entrons are the heat energy produced by the electric current flowing through the resistor. When entrons are lost in a light emitting diode they escape as photons with energies corresponding closely with the diode supply voltage. When batteries are connected in series, entrons representing the battery voltage add to the energy of the electrons at the low voltage terminal of each battery, so three 12-volt batteries in series will produce electrons with entron energies of about 36 eV.

Let us consider three 12 volt batteries (A, B and C) connected in series. At the low voltage terminal of 12 volt battery A, each conduction electron will hav absorbed an entron with a diameter corresponding to ground energy. At the high voltage terminal all conduction electrons will have a diameter of about 1.1×10⁻¹⁰ m. At the low voltage terminal of a 12 volt battery B all conduction electrons will have captured an entron with the same energy and diameter as the electrons at the high voltage terminal of battery A (i.e. 12 volts and 1.1×10⁻¹⁰ m) Electrons at the high voltage terminal of battery B will be at 24 eV with entron diameters of 0.55×10⁻¹⁰ m and the corresponding high voltage terminal of battery C all conduction electrons will be at an energy of 36 eV with entrons with diameters of 0.75×10⁻¹⁰ m.

### Electric Current

At normal temperatures all electrons in atoms other than conduction electrons are in their ground states and are orbiting around or through the nuclei of an atom. These electrons typically have no captured entrons and in the Ross Model they are called naked electrons as explained above. They are circling the nucleus at an average velocity of about 2.18×10⁶ m/s. Conduction electrons in an atomic matrix typically are not attached to any atom and are moving freely in the matrix of atoms. The conduction electrons typically have captured at least one entron and would be traveling at a velocity different from 2.18×10⁶ m/s (usually slower). Entrons captured by atomic electrons (in addition to normally slowing them down) also put them in excited states. They drop from their excited states to a lower excited state or ground state by releasing the entrons (often as photons) and if they release all of their entrons to return to the ground state they speed back up to 2.18×10⁶ m/s. The entrons captured by conduction electrons define the electron's energy or voltage. The tronnies of low-energy entrons (less energetic than 13.6 eV) loop through electrons and the Coulomb forces from the looping tronnies provide a backward force on the electrons to slow down the electrons to reduce the electron velocity and kinetic energy. A 13.6 eV entron reduces the electron velocity to about zero. Higher energy entrons give the electron a velocity that can be any velocity up to 1.414 times the speed of light in a direction opposite the direction of its naked velocity.

As indicated by Table V, entrons with energies in the range of a few volts have dimensions about the size of atoms (about 10⁻¹⁰ m) and as indicated by FIG. 3D, electron speeds are normally a fraction of the speed of light. Therefore, the association between an electron and the entron it has captured is probably a very loose one. So entrons can jump off a high-voltage electrons coming out of the battery and travel through a conductor very quickly until all of the conduction electrons in the conductor have captured entrons of the same energy. At this point the entire conductor between the battery and the lamp is charged to 12 volts. As billions of capturing electrons near the lamp attempt to pass through (at almost the same time) the filament of the lamp the entrons escape from the capturing electrons and become quanta of heat in the filament. As explained below entrons captured in matter are the heat quanta in the matter and define the temperature. The more captured entrons the greater the heat and the higher the temperature. Entrons captured in matter can share energy with each other to produce an energy distribution. Some of these entrons will escape the filament in the form of photons. If the temperature is high enough some of these photons will be visible light photons.

### Self-Propelled Velocities of Sub-Atomic Particles

According to the Ross Model, sub-atomic particles are all self-propelled by the Coulomb forces of the tronnies of which they are made. All tronnies are self-propelled at velocities of the speed of light, c, or greater. Entrons in photons are self propelled in a circle at a velocity of 2 times the speed of light and photons are self-propelled at a velocity of c (the measured speed of light in a vacuum). “Naked” electrons and “naked” positrons are self-propelled at a velocity of 2.18×10⁶ m/s giving them a “naked kinetic energy” (½)(mv²)=( 1/2)(9.109×10⁻³¹ kg)(2.18×10⁶ M/s)²=2.16×10⁻¹⁸ J or about 13.5 eV. Naked electrons and naked positrons capture low energy entrons to slow down, but the capture of entrons with energies greater than about 13.5 eV drives them in directions opposite their natural direction. Naked protons are also self-propelled by their own internal Coulomb forces at velocities of about 4.02×10⁷ m/s (a little more than 13 percent of the speed of light) giving them a kinetic energy of about 8.37 MeV. The naked proton must capture about 8.37 MeV of entron energy in order to slow down enough to capture an electron to form a hydrogen atom. Much of this entron energy is given up as gamma ray energy when hydrogen nuclei fuse to form helium.

### Special and General Relativity

### Special Relativity

A very important feature of the Ross Model is that photons travel in Coulombic reference frames at the vacuum speed of light. If the reference frame is moving in the same direction as the photon with a particular velocity vr then the photon velocity is vr+c. If the reference frame is moving with a velocity of vr in the opposite direction of the photon then the photon's speed is c−vr. For example, if a Coulombic reference frame, such as that of the earth, is moving through our Universe at a speed of 0.1 percent c in a direction opposite the direction of a light beam, the light beam passing through the Coulombic reference frame will slow down to 99.9 percent c. If the reference frame is moving at a speed of 0.2 percent c in the same direction of a light beam passing through it, the light beam will speed up to a speed of 100.2 percent c. So that someone measuring the speed of light with equipment moving with the reference frame will measure the speed of light as the difference between (1) the speed of the frame and (2) the speed of light. In both cases the measured speed of light will be constant at c. Einstein assumed that the speed of light was constant based on the results of the Michelson-Morley experiments that showed that the “measured” speed of light is always constant. This explanation of light speed makes some of the most complicated features of the Special Theory of Relativity unnecessary.

### General Relativity

Einstein's did not recognize that matter-penetrating photon neutrino photons are responsible for gravity. My discovery that neutrinos (my neutrinos, neutrino photons, not the prior art neutrinos) “carry” gravity makes most of the complicated features of General Relativity unnecessary if not wrong. Certainly, masses do not curve space. Space is merely the emptiness between things—it is nothing, you can't curve it. Space is also infinite in all three dimensions and there are only three dimensions: up and down, left and right and forward and backwards. Time is not a forth dimension; time is a measurable period between events. Time is absolute and is not affected in the least bit by how fast one is moving. My model brings logic back into science. If a fast train A is traveling east at 0.9 c and fast train B is traveling west toward train A on the same track at 0.9 c. People watching from train station C equidistance from the two trains, as well as people watching from each train will all conclude that the two trains are approaching each other at 1.8 c. If a galaxy is moving away from the earth at 0.9 C and a space ship is flying within the galaxy at a speed of 0.9 c relative to the center of the galaxy in the same direction that the galaxy is moving, that space ship is traveling at 1.8 c away from the earth.

### Uncertainty Principal

The prior art idea that uncertainty is a basic element of physics is wrong. There may be things going on that we have no way of measuring precisely, but the physics is completely precise. Coulombs law and its derivations apply to infinitely small dimensions and at all speeds. The fundamental particles in the universe are point particles so their position should be infinitely precise. Coulombs law is infinitely precise, at least as far as we know. Time is absolute. There is no limit to how many times you can divide a second. So the universe is infinitely precise. Currently, our instruments are not infinitely precise, but they are getting better and better.

### Tronnies Are Required by Coulomb's Law

Coulomb's Law says that the force between two charges is proportional to the product of the charges and inversely proportional to the square of the distance between them. At distances infinitely close to zero, the Coulomb force approaches infinite. A consequence of this law is that elementary charged particles must be point charges with no volume or any other dimension. Otherwise, the elementary charged particle would blow itself apart with infinite or near infinite force. It is obvious that a point cannot have mass. Infinite density makes no sense. Therefore, all charged particles must be charged point particles or be made up of charged point particles. This is the essence of the Ross Model. The question is: “Could an elementary charged point particle travel at speeds less than the speed of light.” The answer is “No”. The Coulomb force on a charge A from a like charge A′ is felt by A based on the position of A′ when the force (traveling at the speed of light and reaching A) left A′. Therefore, if a mass-less point charge ever attained a speed equal to or greater than the speed of light, forces from its own past would assure that it never slowed down to a speed of less than the speed of light. I believe no tronnie ever traveled more slowly than the speed of light but if it did the Coulomb forces from two nearby like charges (each pushing the particle at the speed of light) would drive the mass-less point particle away at speeds greater than the speed of light. Once it is going away from a past position of itself faster than the speed of light its own past (especially its immediate past) will keep it going at least the speed of light. Therefore, we can assert that every elementary charged particle in the universe must be a mass-less point particle doomed to always travel at speeds equal to or greater than the speed of light.

### Are Photons a Particles or Waves?

The prior art does not know whether light is a wave or a particle. The Ross Model says a photon is both a wave and a particle. The entron portion of the photon is a particle in the same sense that an electron is a particle. (An entron is comprised of two tronnies and an electron [a naked electron] is comprised of three tronnies.) The entron carries the mass of the photon. The entron can exist in many forms other than as a component of a photon. It can be captured by an electron or a proton to become part of the electron or the proton. It can be trapped in matter in the form of a heat quantum, later to be released as part of another photon. But the entron and all the other entrons in a beam of light with their charges produce Coulomb force waves that travel out from their positions spherically to produce a Coulomb wave structure that the entrons in the beam ride in. The entron of a single photon can create a complex wave traveling at the speed of light on which the photon can travel at the speed of light through a laboratory or through our Universe. The photon is the combination of the entron particle and the Coulombic wave the entron produces in which the entron rides. So the photon is a particle and a wave!

### Reflection and Refraction

The looping path of the entron viewed from the Coulombic reference frame through which the photon is traveling has the speed of the entron varying from 3 c to minus c and dropping to zero once each wavelength of the photon. The entron travels backwards through a significant portion of each wavelength. At surfaces such as the surface of a lake, a mirror, a window or a tree leaf, Coulombic fields flow out from the surface at the speed of light perpendicular to the surface. Therefore it is easy for an entron to change directions at surfaces. Entrons floating in a beam of light intersecting these surfaces at an incident angle float in the Coulombic field flowing out from the surface as well as the field of its incoming beam so they often reflect from the surface at a reflection angle equal to the incident angle. Entrons illuminating a material of higher index of refraction that are not relected or absorbed at the surface of a material flow with its wave into the material at a slower speed bending toward the normal to the surface in a wave-like pattern.

### A “Single Photon-Two Slit” Explanation

One of the fundamental mysteries of physics is the single photon-two slit experiment. In this single photons (coming one at a time) illuminating two slits in a first screen produce a diffraction pattern on a second screen. This mystery is described in many physics books. For example, Fundamentals of Physics, Halliday, Resnick and Walker, Sixth Ed., John Wiley & Sons, Inc. at pages 962-964. The question is how could single photons produce diffraction patterns. How could a photon passing through one of the two slits even be aware that there is a second slit? The best explanation the prior art can give is that the light is produced as a photon and is absorbed as a photon but “travels between the source and the detector as a probability wave”. The Ross Model provides a much simpler solution. The entron portion of each photon passes through only one of the two slits but its Coulombic wave passes through both slits and both parts of its wave combine to direct the path of the entron portion of the photon on the opposite side of the first screen.

### Polarization

The two tronnies of each entron spin in a plane. If the entron is the energy portion of a photon, the photon spins in the plane of the entron spin which also includes the photon direction. In most light beams the spin direction of the entron and its photon is random about the photon direction (the photon axis). Light beams become partially polarized upon reflection from smooth surfaces. This is because the entrons want to circle parallel to both the direction of the beam and the direction perpendicular to the surface. This is natural for the plane that includes the directions of incoming beam and the reflected beam, so this is one of the polarizations. This plane includes the normal to the surface. The other reflected polarization is perpendicular to that direction. I recognize that this explanation of polarization appears a little flakey. I have tried many explanations of polarization but none seem really simple. I have also tried to understand polarization under other theories of light. None really make much sense to me. Light can be polarized by a number of techniques other than reflection and the polarization of a light beam can be changed with wave plates and it can be rotated with magnetic fields. I believe my model can explain polarization but it is probably going to take someone much more expert in optics than I who is a believer in tronnies and entrons to provide that explanation.

### Photon Absorption

When photons react with matter, they may be reflected or transmitted without loss of energy. They may also be absorbed to create an excited atom or molecule. And they may be absorbed in the matter as heat energy. High-energy x-rays and gamma rays are attenuated via the photo-electric effect, Compton scattering or pair production. It is the entron that is the energy/mass of the photon. When the photon is trapped in matter for a short time or for a very long time, it ceases to exist as a photon but its entron does not cease to exist. It can however transfer part of its energy to other entrons or the tronnies of entrons can change partners with the tronnies of another entron. For example, more than one entron can be captured by the same electron. When this happens, the tronnies of the one of entrons is brought closer to the tronnies of a separate entron than it is to its partner. The result can be a higher energy entron and a lower energy entron. In a microwave oven entrons of a single relatively low frequency become absorbed in what is cooking and the result is a hot product with a wide range of entron energies. These are radiated away or conducted away as the product cools. As discussed above, three entrons (a neutrino entron a 1.05 MeV gamma ray entron and a low energy entron) can produce an electron and positron pair. Most entrons trapped in matter radiate from the matter in the form of photons In a reaction described as the photoelectric effect, the entron portion of the photon is absorbed by an electron giving the electron all of the entron energy. In Compton scattering the entron is absorbed by an electron, but an entron previously a part of the electron is ejected and we monitor the ejected entron as a photon.

### Heat and Temperature

Heat is nothing more than entrons (circling tronnie pairs) temporarily trapped in matter. Temperature is a measure of that heat. We warm up when our bodies absorb the entrons of photons radiated from a camp fire or the sun, and we cool down when our body radiates photons with wavelengths in the millimeter wave range. The entrons of microwave radiation warms our TV dinners. We typically must wait a few minutes for some of the entrons to radiate away so that the dinners have cooled enough for us to eat them. According to this embodiment heat and temperature, of a solid, liquid or gas, are expressions of entrons (or tronnie pairs) which have been captured and are temporarily located in the solid liquid or gas. According to this model, all atoms and molecules naturally include a number of tronnie pairs (entrons of neutrinos, gamma rays and other photons) that help define the basic atom or molecule in its natural unheated state (i.e., its absolute zero temperature state).

### The Life and Death of Universes

### Recycling on a Grand Scale

Each universe has a lifetime. It is born from a basketball size in a Big Bang, expands very quickly at first then more slowly for a long period of time (such as about 50 billion years) to a volume many billions of light years across; then it contracts for another long period (such as another 50 billion years) then it collapses to basketball size and dies in another Big Bang that is the beginning of the next universe. This is recycling on a grand scale! So, according to this model the universe we live in is a number in a series of universes. I doubt if we will ever know what the number of our universe is. We could guess. For example, we might propose that our Universe is Universe 47, created at the demise of Universe 46 and when our universe ends in the next Big Bang its recycled tronnies will create Universe 48. Scientist estimate that our universe is about 15 billion years old and is still expanding. The Ross Model attributes this expansion to the pressure produced by the impact of relatively low energy photon exchanged between far away galaxies. Neutrino photons are absorbed and/or scattered by hydrogen currently sparsely dispersed in inter-galactic space.

### The End of our Universe

It may be that when a sufficient portion of the free hydrogen in the space between galaxies has been sucked into galaxies, the neutrinos from the black holes of the separate galaxies will begin to pull all galaxies together into one gigantic black hole. This largest of all black hole may exist for a long time continuing to suck in surrounding matter and breaking it down to protons and then destroying the protons to produce neutrino photons and gamma ray photons as described above. At some point in the life of the largest of all black hole, the process of proton destruction will accelerate providing an exponential increase in the black hole's gravity which further accelerates the proton destruction so that in a very short period (maybe less than a few seconds) the black hole collapses to a size smaller than a basketball and all remaining protons and electrons are destroyed so that nothing is left but gamma ray photons and neutrino photons which explode out a basketball size birthplace in a Big Bang to create our successor universe.

### The Birth of the Next Universe

Following the Big Bang destruction of this largest of all black holes, the released neutrino and gamma ray photons expand out much faster than the speed of light. This is the inflation period of the next universe. A reader may ask, “How can photons go faster than the speed of light?” In the Ross Model light speeds up as it passes into a Coulombic field moving in the same direction as the light. For example, if a Coulombic field moving out at the speed of light is produced by a group of photons expanding from the center of the black hole, then a second group of photons surrounding the first set could move out at twice the speed of the first group. Then a third group of photons surrounding the second group could move out at three times the speed of light. We can imagine a great many of groups of photons; so the speed of the last group could be any speed many times faster than the speed of light. The prior art suggest that at the very beginning of our universe there was this inflation period where the universe did in fact expand out much faster than the speed of light, but the prior art does not have an explanation for the fast expansion. And this explanation is at odds with the prior art theories since those theories limit all speed at the speed of light. The Ross Model has no such limit.

The principal products of the destruction of protons and the Big Bang as explained above are gamma ray photons and neutrino photons. When the new universe has expanded sufficiently, gamma rays and neutrino photons and low-energy photons will begin combining to form electrons and positrons each of which can capture one of the many neutrino photons that were released to produce very high-energy electrons and positrons. These now combine to form naked protons. Some of these naked protons combine with three other naked protons to form alpha particles but most capture entrons having combined energies of 8.37 MeV entron and form hydrogen atoms. During this process the creation of hydrogen and helium retards the distribution of lower energy photons but not neutrino photons. The lower energy photons provide an expansion force and the neutrino photons provide a gravitational force so that matter in the universe tends to congregate. At great congregations lower energy photons are absorbed and neutrino photons are scattered randomly out of the congregation providing a type of gravity for the congregation producing further congregation. So stars and galaxies and black holes are born. Stars generate larger atoms in fusion processes and heavier atoms are produced in explosions of stars. Planets are formed from the dust of the universe and in due course life evolves on some of the planets.

### String Theory

I do not understand string theory; however, I do understand that many very smart people believe in it because it produces results that are consistent with experimental results. The End of the Universe

### The Ross Model is Evolving

I admit that some of my explanations are speculative and I am sure that people more familiar with particular technologies than I can improve on my explanations. When they do I will just modify my model to accommodate the better explanations. As is clearly obvious from a review of the parent patent applications preceding this one, I have already modified my model numerous times since I began developing it about four years ago. The model has gotten simpler with each modification.

The reader should understand that this theory is not fully developed. It has been evolving for about seven years. It started with an attempt to show that protons could be made from positrons and electrons. A five electron model was proposed (three positrons and electrons orbiting one of the positrons fast enough that their velocity very close to the speed of light would increase their mass by about 900 times. Later on I developed the idea that electrons must be made from photons. This seemed likely since that is how electrons are made in pair production. What was added was the notion that both photons and electrons are made from charged things, called tronnies. Since tronnies have no mass, they could go faster than the speed of light; therefore, they could be pushed by their own Coulomb force field. My first attempt at an electron model had one tronnie in the center with two opposite tronnies orbiting. Once I had an electron model made from the constituents of photons, I went to work trying to make everything out of tronnies. I developed models for heat, electricity, magnetism. I at this point convinced myself that everything in the universe must be made from tronnies. My first electron model was not very satisfying because nothing seemed to keep it from collapsing on itself. Also, it was hard to understand how the central tronnie could go as fast as the speed of light. Then I developed the triple tronnie twirl and this model seemed perfect. It had spin. It had to have a non-zero volume since the outer tronnies had to pass through the circular path of the central tronnie. Not only that, it seemed to provide a good model for the proton especially if I was correct that captured tronnie pairs provided electrons with their excess energy (and mass). Having gone this far, maybe I really could show the possibility of everything in the universe being made from tronnies and all forces in the universe being derived from tronnies.

The most difficult was gravity. The breakthrough was my realization that neutrinos might be photons and (like photons) be comprised of two opposite charges. This is almost too simple. I had tried for almost three years to describe gravity in terms of the Coulomb force. My calculations would not work out. I could never come up with an inverse square relationship. Now, however, I realized that the thing that was known in the prior art as a neutrino might really be a high-energy photon. The neutrino flux was known to be huge and it decreases from its source as the inverse square. I had earlier showed that a photon (or a tronnie for that matter) traveling at the speed of light exerts no force in front of itself but would exert a force behind itself pushing toward its source. And almost all neutrinos form the sun were thought to pass completely through the earth, billions and billions and billions of them each second, all pushing the earth back from wince the neutrinos came. This must be gravity! I think I got it! I think I got it! However, I have later revised my neutrino model. My neutrino as explained above is not the prior art neutrino. My neutrino is a very high energy photon. And maybe they are all produced in black holes as the result of proton destruction. But these neutrinos do provide the gravity of our Universe.

Another important improvement has been my discovery and identification of the entron the improved description of the photon with the entron carrying the photon energy. This allowed me to correlate the photon's energy with the entron's integrated Coulomb forces. Still another improvement has been my realization that the speed of light slows down or speeds up when it passes through a Coulombic force field. So its speed measured by people and equipment moving with the Coulombic force field is always constant. Thus, the vacuum speed of light is not constant. This meant that most of the complicated features of the Special Theory of Relativity are wrong. Time is absolute and is the same in all reference frames no matter how fast they are moving relatively to each other. Things do not shrink or stretch when you go fast. They stay the same size. Important improvement first described in this application are may discovery that three photons are required for pair production and that subatomic particles are self propelled in their naked state and need to capture entrons to slow down. This latter discovery allowed me to solve a riddle only partially solved by Niels Bohr more than 100 years ago. Most orbiting electrons do not radiate photon energy because they have no photon energy to radiate. This discovery also allowed me to show where fusion energy comes from.

### The Correctness of the Models

I have in this specification attempted to provide fairly detailed models for all of the basic elements. This has required a very large amount of imagination and speculation on my part. The models presented in this specification (including the models of the photon, the electron, the proton and the model of atomic nuclei presented above) constitute major departures from the most widely accepted theories explaining the makeup of nuclear particles. The Ross Model and this invention is not limited to the specific models I have described. The invention will be limited by the claims that are allowed by the United States Patent Office. The reader should understand that the models presented herein are evolving. Some are going to be proven incorrect in all likelihood. I expect to develop better models. I am sure others will also if it turns out that I am generally on the right track with the concepts described in this specification.

### Testing the Models

Many processes are available for utilizing, testing and develop the models described herein. One process is for a person experienced in modern nuclear physics to evaluate the models as they have been presented in this specification. This can easily be accomplished with a hand calculator. A more sophisticated model would be to utilize a digital computer model incorporating one or more of the models. It should be fairly simple to model the tronnies, the positrons the negatrons the protons and neutrons in the electron and proton models and determine if they are stable. If I am right, these models will show that the electron and proton and their antiparticles should be enormously stable except when they combine with their anti-particles. By making the computer model a little more complicated, it should be feasible to determine how hard it would be to make a proton using the technique described above for doing that. Perhaps then the computer model could be extended to predict the formation of protons in the models during the process that followed the big bang. Once the electron, proton and neutron have been modeled on a digital computer it would be relatively simple to create similar computer models to examine the Nuclear Models. The techniques herein should also be very valuable in the understanding and design of communication systems from radio, microwave to fiber optics. In each case two heretofore unknown things, the tronnie and the entron, are the workhorses in making these systems work. Now we should really understand why these systems work and as a result maybe make them work better.

### Nuclear Tests and Experiments

If computer modeling shows that the models are correct or that modifications or derivations of the models are correct. A next step is to perform some experiments with particle accelerators to test the models or aspects of the models. It may be that current accelerators do not have the capabilities to properly investigate the models. If so and if the models are shown to be possibly correct then perhaps accelerators can be built to properly test the models. Actually, since the filing of the parent to this Application, Applicant has read that already experiments have been conducted in which positrons and negatrons were fired at each other each with high energy and the result was protons! Also, as referred to above, experiments have been reported in which the annihilation of protons and anti-protons produced electrons and positrons. We have known for many years that electrons and positrons can be produced form photons and that the annihilation of electrons and positrons produce photons. All of these experiments support the models described above.

### No Quarks, No Special Weak Force, No Strong Force

This model shows how nuclei can be held together by Coulomb forces which unquestionably exist. Therefore, there is no need to invent nuclear forces for which there is no proof of existence such as the special weak nuclear force and the strong nuclear force. Also, since the above model shows how protons and neutrons can be held together in the nuclei of atoms there is no need to invent quarks for which there is no good experimental evidence.

Where do Tronnies Get their Charge

For my last topic I will try to describe the Coulomb charge. We know that the Coulomb charge—the charge of e—is the charge of an electron, a positron or a proton, also according to the Ross Model the charge of the plus tronnie and the minus tronnie. This charge expands out in all directions at the speed of light forever applying forces continuously yet never diminishes. How can this be? My only explanation is that tronnies move throughout Universe in Coulombic fields where Coulomb force waves originating from other tronnies are traveling at the speed of light. These force waves from billions of tronnies just happen to concentrate at points and at each of those exact points is where a tronnie just happens to be. The waves then expand out from the tronnie in all directions at the speed of light an the tronnie rides his wave at the speed of light or faster.

### Predictions of the Ross Model

Here are some predictions of the Ross Model. A number between 1 and 9 follows each prediction which is my current rough estimate of the probability that the prediction is correct. A “9” means I am more than 90 percent confident I am right. A “1” means that I am more than 10 percent confident that I am right. No number means I don't want to guess on the likelihood of the correctness of the prediction. In any case, I challenge all readers to prove me wrong or right.

### Tronnies

Our universe is comprised of nothing but tronnies and things comprised of tronnies. (9)
Tronnies have no mass and no volume. (9)
Tronnies have a charge of plus or minus e (about 1.6×10⁻¹⁹ Coulomb). (9)
The number of plus and minus tronnies in our Universe is equal. (6)
Tronnies can not be destroyed. (4)

### Entrons

Plus and minus tronnies combine to form entrons to create an energy quantum. (8)
In entrons, the tronnies circle at speeds of about 1.57 c. (7)
In entrons net integrated Coulomb forces equate to quantum energy. (6)
The entron's quantum energy is equivalent to mass. (6)

### Photons

Each photon is comprised of one entron that is comprised of two tronnies. (9)
The mass of the entron is also the mass of the photon. (6)
The photon mass is equal to its total energy (5)
In a photon the entron travels at a speed of twice the speed of light. (6)

### Electrons

Three gamma ray entrons combine to form an electron-positron pair. (8)
There are an equal number of electrons and positrons in our Universe. (7)
A “naked” electron is comprised of three tronnies. (9)
Most electrons orbiting in atoms are naked electrons. (8)
Naked electrons capturing low-energy entrons slow down. (8)
High energy electrons are propelled by high energy entrons. (7)

### Protons

Each proton is comprises of two positrons and one negatron (8)
Each of the three electrons in the protons has captured the entron of neutrino photon (8)
Captured entrons of neutrino photons represent more than 99.8 percent of the proton mass. (7)
Naked protons are self-propelled with internal Coulombic forces. (8)
Naked protons capture gamma ray entrons to become typical atomic hydrogen. (8)
High-energy gamma ray entrons are given up by hydrogen during fusion. (8)

### Neutrons

Neutrons are protons with an orbiting high energy electron. (7)
The high energy electron is an electron with a captured entron of a gamma ray photon. (7)

### Atomic Nuclei

An alpha particle is comprised of four naked protons and two negatrons. (7)
There is only one basic force operating in our Universe, the Coulomb force. (8)
There is no “strong force” holding atomic nuclei together. (9)
There is no such thing as quarks (6)

### Gravity

Gravity is carried by neutrino photons. (7)
Our gravity comes from neutrino photons released from destroyed protons in our black hole. (5)

### The Speed of Light

Light slows down when passing through Coulombic fields heading in an opposite direction. (6)
Light speeds up when passing through Coulombic fields heading in a same direction. (6)
Our earth drags a strong Coulombic field through the universe. (6)

### Variations

Persons skilled in this art will recognize that many changes and variations to the specific embodiments of the present invention are possible so the reader should understand that the scope of the present invention should be determined by the appended claims and their equivalents.

I claim:

1. A process for making models of elements of our Universe comprising steps of:
A) creating a representation of a fundamental point particle having zero mass, zero volume and a charge of about plus 1.9×10⁻¹⁹ coulomb or minus 1.9×10⁻¹⁹ coulomb defining a minus tronnie, each of which fundamental point particles is self-propelled at speeds never less than the speed of light,
B) utilizing such representations of point particles to create models of small particles.

2. The process as in claim 1 wherein said small particles are subatomic particles.

3. The process as in claim 1 wherein the small particles include a particle comprised of nothing but one plus tronnie and one minus tronnie circling a common center and defining an entron and an entron diameter.

4. The process as in claim 3 wherein the two tronnies are modeled as circling at speeds of about 1.57 c.

5. The process as in claim 3 wherein a photon is modeled as being comprises of nothing but an entron.

6. The process as in claim 5 wherein the entron is modeled as traveling in a circle at a speed of 2 c and forward at a speed of c.

7. The process as in claim 1 wherein a naked electron is modeled as being comprised of a plus tronnie circling with a diameter of about 1.46×10⁻¹⁸ m and two minus tronnies circling the path of the plus tronnie also with a diameter of about 1.46×10⁻¹⁸ m.

8. The process as in claim 7 wherein said two minus tronnies are modeled as circling behind the plus tronnie by one fourth of the plus tronnies period.

9. The process as in claim 8 wherein a positron is modeled an an anti-particle of the electron.

10. The process as in claim 3 wherein an entron is modeled as having a diameter of about 1.46×10⁻¹⁸ m and defining a neutrino entron.

11. The process as in claim 10 wherein the neutrino entron is modeled as a carrier of gravity.

12. The process as in claim 1 wherein a naked proton is modeled as being comprised of a high energy electron with a captured neutrino entron, with the high-energy electron traveling in a circle with a diameter of about 1.3×10⁻¹⁵ m and having a combined mass equivalent to about 931 MeV and two low-energy positrons circling the path of the high-energy electron.

13. The process as in claim 12 wherein a hydrogen one nucleus is modeled as being comprised of a naked proton with a plurality of captured entrons.

14. The process of claim 13 wherein the captured entrons are modeled as having a combined energy of about 8.3 MeV.

15. The process as in claim 14 wherein the combined energy of about 8.3 MeV is modeled as being released in the course of hydrogen fusion to produce helium.

16. The process as in claim 1 wherein our Universe is modeled as having an approximately spherical shell comprised of naked electrons and naked positrons many light years thick.

17. The process as in claim 1 wherein our Universe is modeled as being created at the same time as the demise of our predecessor universe.
